(19) United States
(12) Patent Application Publication
(10) Pub. No.: US 2017/0134369 A1
(43) Pub. Date: May 11, 2017

(54) METHOD AND APPARATUS FOR PROVIDING TIME-ASSISTED AUTHENTICATION PROTOCOL

(71) Applicant: ELECTRONICS AND TELECOMMUNICATIONS RESEARCH INSTITUTE, Daejeon (KR)

(72) Inventors: Muhammad BILAL, Daejeon (KR); Shin-Gak KANG, Sejong-si (KR); Sung-Hei KIM, Daejeon (KR); Juyoung PARK, Daejeon (KR)

(73) Assignee: ELECTRONICS AND TELECOMMUNICATIONS RESEARCH INSTITUTE, Daejeon (KR)

(21) Appl. No.: 15/348,480

(22) Filed: Nov. 10, 2016

(30) Foreign Application Priority Data
Nov. 11, 2015 (KR) 10-2015-0158285
Nov. 10, 2016 (KR) 10-2016-0149678

(51) Int. Cl. H04L 29/06

(52) U.S. Cl. CPC H04L 63/0807; H04L 63/068; H04L 63/0428

(57) ABSTRACT

Disclosed herein are a method and apparatus for time-assisted authentication. A main authentication entity may generate a group of communication entities. In keying protocol a key distributor, i-e main authentication entity, controls the key generation arguments and time factor; other member of the group independently generate the time-based keys using the key generation arguments. Respective keys in the chain of keys may be valid for time intervals predefined for respective keys. A ticket is issued to the valid customer node during initial authentication process, which is further used for re-authentication of customer node with other service providing entities and customer to customer node mutual authentication. A ticket verifier may authenticate a customer node by decrypting the ticket using time based keys.

### CROSS REFERENCE TO RELATED APPLICATIONS

This application claims the benefit of Korean Patent Application Nos. 10-2015-0158285, filed Nov. 11, 2015 and 10-2016-0149678, filed Nov. 10, 2016, which are hereby incorporated by reference in their entirety into this application.

### BACKGROUND OF THE INVENTION

1. Technical Field

The following embodiments relate to a method and apparatus for a secure mutual authentication protocol, which can be used in wireless power transfer, sensor network, and infrastructure-less application services.

2. Description of the Related Art

The present invention issues a ticket for re-authentication like Kerberos. However, unlike Kerberos, a proposed Time-Assisted Authentication Protocol (TAP) scheme encrypts an authentication ticket using a time-based keychain mechanism, as in the case of Timed Efficient Stream Loss-Tolerant Authentication (TESLA); whereas in TESLA the time based key is used to authenticate the broadcasting entity on the other hand in TAP the time based key is used for mutual authentication between service-providing entity and customer node, and customer to customer node

Further, similar to authentication protocols such as Needham-Schroeder, Kerberos, Wide-Mouth-Frog, and Woo-Lam, the proposed TAP maintains a session key between a service-providing entity and a customer node. In these well-known authentication protocols, a session key is derived from specific information associated with the service-providing entity and the customer node, but, in the proposed TAP, a session key is derived from specific information associated with the customer node and time-based information.

In relation to communication technology between multiple nodes that use keys, U.S. Pat. No. 8,300,830 has been published.

### SUMMARY OF THE INVENTION

An embodiment is intended to provide an apparatus and method that provide a secure mutual authentication protocol between a service-providing entity and a customer node in wireless power transfer, sensor network and ad-hoc network applications.

An embodiment is intended to provide an apparatus and method that use a secure and lightweight authentication protocol in a dynamic networking environment.

An embodiment is intended to provide an apparatus and method that authenticate communicating entities with minimal communication complexity.

An embodiment is intended to provide an apparatus and method that reduce a delay in an authentication procedure by authenticating communicating entities with minimal communication complexity.

In accordance with an aspect of the present invention, there is provided an authentication method performed by an authentication entity, including forming a group of communication entities in a network; generating a chain of keys required for authentication in the group; and performing authentication of a customer node based on the keychain, wherein respective keys in the keychain are valid for time intervals predefined for respective keys.

The keys may be generated using an irreversible function.

The keys may be used in the reverse order of direction in which the keys are generated by the irreversible function.

A commitment key of the group and the keys may be generated based on a predefined value.

The predefined value may be a valid time for the commitment key.

The authentication entity may authenticate the customer node using a ticket sent from the customer node.

The selected key may be a key corresponding to a time interval during which a service is provided to the customer node, among the keys in the keychain.

Performing the authentication may include issuing information about a ticket for re-authentication of the customer node to the customer node.

In accordance with another aspect, there is provided an authentication entity, including a processing unit for forming a group of communication entities in a network, generating a chain of keys required for authentication in the group, and performing authentication of a customer node based on the keychain; and a communication unit for receiving a request for authentication of the customer node and sending a response to the request, wherein respective keys in the keychain are valid for time intervals predefined for respective keys.

In accordance with a further aspect, there is provided an authentication method performed by a service-providing entity, including sending a request to join a group of communication entities in a network to an authentication entity; receiving key generation information from the authentication entity; and generating a chain of keys required for authentication in the group based on the key generation information, wherein respective keys in the keychain are valid for time intervals predefined for respective keys.

The authentication method may further include receiving a request for a service from a customer node; and sending a response to the service request to the customer node.

The response to the service request may include information about a ticket issued by an authentication entity that performs authentication of the customer node.

Information about at least a portion of the ticket may be encrypted with a time-based key that is valid for a predefined time interval, among the keys in the keychain.

The authentication method may further include receiving a request for a service from a customer node; and sending a response to the service request to the customer node.

The service request may include information about a ticket for re-authentication of the customer node.

Information about at least a portion of the ticket may be encrypted with a time-based key that is valid for a predefined time interval, among the keys in the keychain.

In accordance with yet another aspect, there is provided a service-providing entity, including a communication unit for sending a request to join a group of communication entities in a network to an authentication entity, and receiving key generation information from the authentication entity; and a processing unit for generating a chain of keys for authentication in the group based on the key generation information, wherein respective keys in the keychain are valid for time intervals predefined for respective keys.

In accordance with still another aspect, there is provided an authentication method performed by a customer node, including sending a request for a first service to a first service-providing entity; and receiving a response to the request for the first service from the first service-providing entity, wherein the response to the request for the first service includes information about a ticket issued by an authentication entity that performs authentication of the customer node, and wherein information about at least a portion of the ticket is encrypted with a time-based key that is valid for a predefined time interval.

The authentication method may further include sending a request for a second service to a second service-providing entity; and receiving a response to the request for the second service from the second service-providing entity.

The request for the second service includes information about the ticket for re-authentication of the customer node.

The ticket may include a first part and a second part, and

The first part may be encrypted with a time-based key that is valid for a predefined time interval.

The second part may be encrypted with a group key of a group of the authentication entity.

The second part may include information used to determine the time-based key required to decrypt the first part.

The ticket may be derived based on the customer node-specific information.

In accordance with still another aspect, there is provided a customer node, including a communication unit for sending a request for a first service to a first service-providing entity and receiving a response to the request for the first service from the first service-providing entity; and a processing unit for generating a message including the request for the first service, wherein the response to the request for the first service includes information about a ticket issued by an authentication entity that performs authentication of the customer node, and wherein information about at least a portion of the ticket is encrypted with a time-based key that is valid for a predefined time interval.

In addition, other methods, apparatuses and systems for implementing the present invention, and a computer-readable storage medium for storing a computer program for executing the methods, are further provided.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a system for providing a Time-Assisted Authentication Protocol (TAP) according to an embodiment;

FIG. 2 is a configuration diagram of a main authentication entity according to an embodiment;

FIG. 3 is a configuration diagram of a service-providing entity according to an embodiment;

FIG. 4 is a configuration diagram of a customer node according to an embodiment;

FIG. 5 illustrates the architecture of a system for providing a TAP according to an example;

FIG. 6 is a flowchart showing an authentication method according to an embodiment;

FIG. 7 is a flowchart showing a group formation method according to an example;

FIG. 8 is a flowchart showing a group formation method when Pᵢ falls within the communication range of MEⱼ according to an example;

FIG. 9 is a flowchart showing a group formation method when Pᵢ does not fall within the communication range of MEⱼ according to an example;

FIG. 10 illustrates a time frame related to the generation and usage of time-based keys according to an example;

FIG. 11 illustrates the generation and admission of time-based keys in relation to the passage of time according to an example;

FIG. 12 illustrates the structure of a function g according to an example;

FIG. 13 illustrates the structure of a function F according to an example;

FIG. 14 illustrates the structure of a function ƒ according to an example;

FIG. 15 is a flowchart showing an authentication procedure according to an embodiment;

FIG. 16 is a flowchart showing an initial authentication method according to an embodiment;

FIG. 17 is a flowchart showing a first case of re-authentication according to an example; and

FIG. 18 is a flowchart showing a second case of re-authentication according to an example.

### DESCRIPTION OF THE PREFERRED EMBODIMENTS

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

The terms used in the present specification are merely used to describe specific embodiments and are not intended to limit the present invention. In the embodiments, a singular expression includes a plural expression unless a description to the contrary is specifically pointed out in context. In the present specification, it should be understood that terms such as “comprises” and/or “comprising” are merely intended to indicate that components, steps, operations, and/or elements are present, and are not intended to exclude the possibility that one or more other components, steps, operations, and/or elements will be present or added. Such added configurations may be included in the scope of the practice of exemplary embodiments or the scope of the technical spirit of the exemplary embodiments. It will be understood that when a component is referred to as being “connected” or “coupled” to another component, it can be directly connected or coupled to the other component, or intervening components may be present between the two components.

Terms such as ‘first’ and ‘second’ may be used to describe various components, but the components are not restricted by the terms. The terms are used only to distinguish one component from another component. For example, a first component may be named a second component without departing from the scope of the present invention. Likewise, a second component may be named a first component.

Also, components described in the embodiments of the present invention are independently shown in order to indicate different characteristic functions, but this does not mean that each of the components is formed of a separate piece of hardware or software. That is, components are arranged and included separately for convenience of description. For example, at least two of the components may be integrated into a single component. Conversely, one component may be divided into multiple components. An embodiment into which the components are integrated or an embodiment in which some components are separated is included in the scope of the present invention as long as it does not depart from the essence of the present invention.

Further, some components are not essential components for performing essential functions, but may be optional components for improving only performance. The embodiments may be implemented using only essential components for implementing the essence of the embodiments. For example, a structure including only essential components, excluding optional components used only to improve performance, is included in the scope of the embodiments.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted.

The following embodiments may relate to a service-providing entity and a customer node. The service-providing entity and the customer node may dynamically join a network system. Further, the service-providing entity and the customer node may leave the network system.

As in the case of Kerberos, a Time-Assisted Authentication protocol (TAP) in the embodiments may issue a ticket for re-authentication in the network system. Meanwhile, unlike Kerberos, a TAP may encrypt an authentication ticket using a time-based keychain mechanism as in the case of Timed Efficient Stream Loss-Tolerant Authentication (TESLA); whereas in TESLA the time based key may be used to authenticate the broadcasting entity on the other hand in TAP the time based key may be used for mutual authentication between service-providing entity and customer node, and customer to customer node

Further, similar to authentication protocols such as Needham-Schroeder, Kerberos, Wide-Mouth-Frog, and Woo-Lam, a TAP may maintain a session key between the service-providing entity and the customer node.

On the other hand, unlike such popular authentication protocols, a session key in the TAP may be derived from the service-providing entity and information specific to the customer node. The session key of the TAP may be derived from the customer node-specific and time-based information. The customer node may use the same session key for communication with multiple service-providing entities.

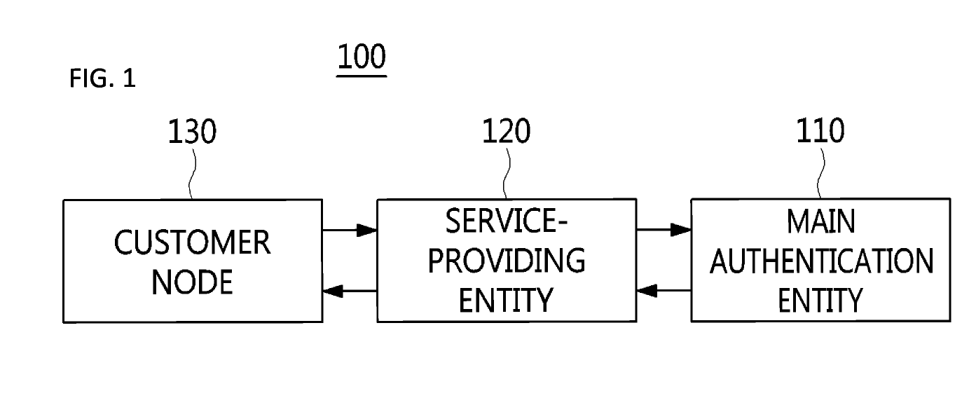

FIG. 1 illustrates a system for providing a TAP according to an embodiment.

A system 100 for providing a TAP may include, as three major entities, a main authentication entity 110, a service-providing entity 120, and a customer node 130.

Main Authentication Entity

The main authentication entity 110 may be referred to as an “authentication entity”, “authentication server” and/or “authentication device”.

The main authentication entity 110 may form a group and may authenticate the customer node.

The main authentication entity 110 may be made aware of the public keys of the service-providing entity 120 and the customer node 130 in advance.

The main authentication entity 110 is responsible for the initial authentication of the customer node 130, and may perform initial authentication of the customer node 130.

Further, the main authentication entity 110 may issue a time-based ticket Tₖ for re-authentication of the customer node 130 to the customer node 130.

Furthermore, the main authentication entity 110 may authenticate a new service-providing entity in the system 100 so as to include the new service-providing entity in a group.

During the authentication procedure, the main authentication entity 110 may send the requirement profile of the customer node 130 to the service-providing entity 120 to establish an efficient and optimized relationship between the service-providing entity 120 and the customer node 130.

Hereinafter, a “requirement profile” may be briefly referred to as a “profile”.

To assure authentication and security, the main authentication entity 110 may use keys that are based on time and are generated in a distributed manner. The main authentication entity 110 may be connected to all other main authentication entities in the system 100 through secure links, and may share public keys with all other main authentication entities.

Service-Providing Entity

The service-providing entity 120 may be referred to as a “server”, “service-providing device” and/or “service device”.

The service-providing entity 120 may provide service to the customer node 130.

The service-providing entity 120 may authenticate the customer node 130. When a valid time-based ticket Tₖ is received from the customer node 130, the service-providing entity 120 may authenticate the customer node 130.

Further, the service-providing entity 120 may start providing service item(s) to the customer node 130 based on the profile of the customer node 130.

Hereinafter, “service item” may be replaced with “service”.

In the initial authentication of the customer node 130, the service-providing entity 120 may forward an authentication request, sent from the customer node 130, to the main authentication entity 110.

In several applications, the service-providing entity 120 may be separated into two parts. For example, the two parts may be a service delivery area Aₛ and a communication area A_{c}. When the customer node 130 is present in Aₛ, the service-providing entity 120 may perform authentication, or may forward an authentication request to the main authentication entity 110. Further, once the customer node 130 enters A_{c}, the service-providing entity 120 may provide service(s) to the customer node 130.

Customer Node

The customer node 130 may be referred to as a “customer device”, “customer terminal” and/or “device”.

The customer node 130 may be provided with service from the service-providing entity 120.

The customer node 130 is responsible for initiation of the authentication procedure. In response to an authentication request from the customer node 130, an authentication procedure in the system 100 may be initiated.

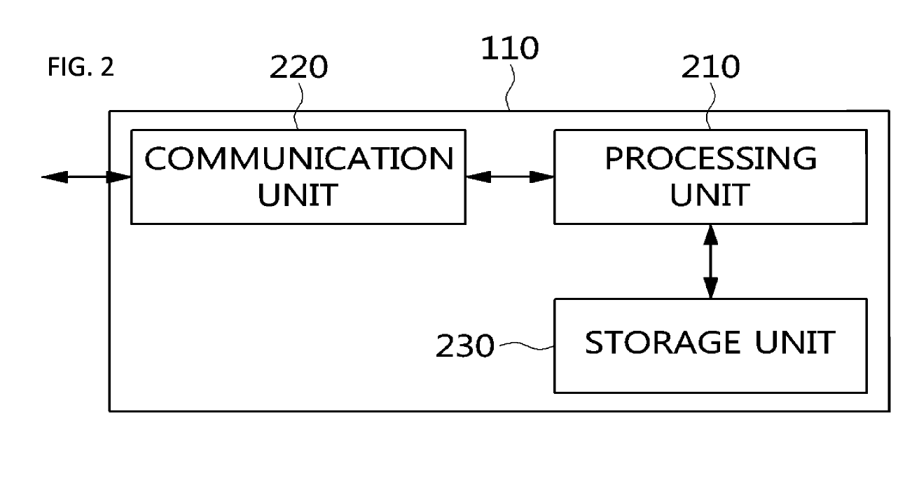

FIG. 2 is a configuration diagram of the main authentication entity according to an embodiment.

The main authentication entity 110 may include a processing unit 210, a communication unit 220, and a storage unit 230.

The processing unit 210 may process tasks required for the operation of the main authentication entity 110. The processing unit 210 may execute code in the operations or steps of the processing unit 210, as will be described in connection with the embodiments.

The processing unit 210 may perform the generation and processing of data or information and may perform examination, comparison, determination, etc. related to data or information. In other words, the generation and processing of data or information and verification, comparison, and determination related to data or information in the embodiments may be performed by the processing unit 210.

For example, the processing unit 210 may perform encryption and/or decryption on data or information. The processing unit 210 may generate messages.

For example, the processing unit 210 may be at least one processor.

The communication unit 220 may receive data or information required for the operation of the main authentication entity 110, and may send data or information required for the operation of the main authentication entity 110.

The communication unit 220 may send data or information to other devices in a network and receive data or information from other devices. In other words, the transmission or reception of data or information in the embodiment may be performed by the communication unit 220.

For example, the communication unit 220 may be a networking chip, a networking interface, or a communication port.

The storage unit 230 may store the data or information required for the operation of the main authentication entity 110. In an embodiment, the data or information of the main authentication entity 110 may be stored in the storage unit 230.

For example, the storage unit 230 may be memory. The storage unit 230 may include an embedded storage medium such as Random Access Memory (RAM) or flash memory, and may also include a removable storage medium such as a memory card.

The storage unit 230 may store at least one program. The processing unit 210 may execute at least one program. The processing unit 210 may read the code of at least one program from the storage unit 230, and may execute the read code.

The operations, functions and features of the processing unit 210, the communication unit 220, and the storage unit 230 of the main authentication entity 110 will be described in detail later with reference to embodiments.

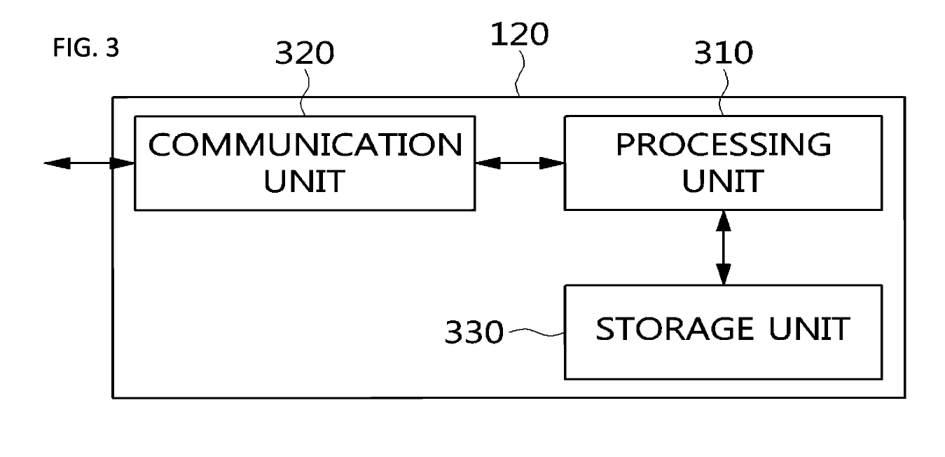

FIG. 3 is a configuration diagram of the service-providing entity according to an embodiment.

The service-providing entity 120 may include a processing unit 310, a communication unit 320, and a storage unit 330.

The processing unit 310 may process tasks required for the operation of the service-providing entity 120. The processing unit 310 may execute code in the operations or steps of the processing unit 310, as will be described in connection with the embodiments.

The processing unit 310 may perform the generation and processing of data or information and may perform examination, comparison, determination, etc. related to data or information. In other words, the generation and processing of data or information and verification, comparison, and determination related to data or information in the embodiments may be performed by the processing unit 310.

For example, the processing unit 310 may perform encryption and/or decryption on data or information. The processing unit 310 may generate messages.

For example, the processing unit 310 may be at least one processor.

The communication unit 320 may receive data or information required for the operation of the service-providing entity 120, and may send data or information required for the operation of the service-providing entity 120.

The communication unit 320 may send data or information to other devices in a network and receive data or information from other devices. In other words, the transmission or reception of data or information in the embodiment may be performed by the communication unit 320.

For example, the communication unit 320 may be a networking chip, a networking interface, or a communication port.

The storage unit 330 may store the data or information required for the operation of the service-providing entity 120. In an embodiment, the data or information of the service-providing entity 120 may be stored in the storage unit 330.

For example, the storage unit 330 may be memory. The storage unit 330 may include an embedded storage medium such as RAM or flash memory, and may also include a removable storage medium such as a memory card.

The storage unit 330 may store at least one program. The processing unit 310 may execute at least one program. The processing unit 310 may read the code of at least one program from the storage unit 330, and may execute the read code.

The operations, functions and features of the processing unit 310, the communication unit 320, and the storage unit 330 of the service-providing entity 120 will be described in detail later with reference to embodiments.

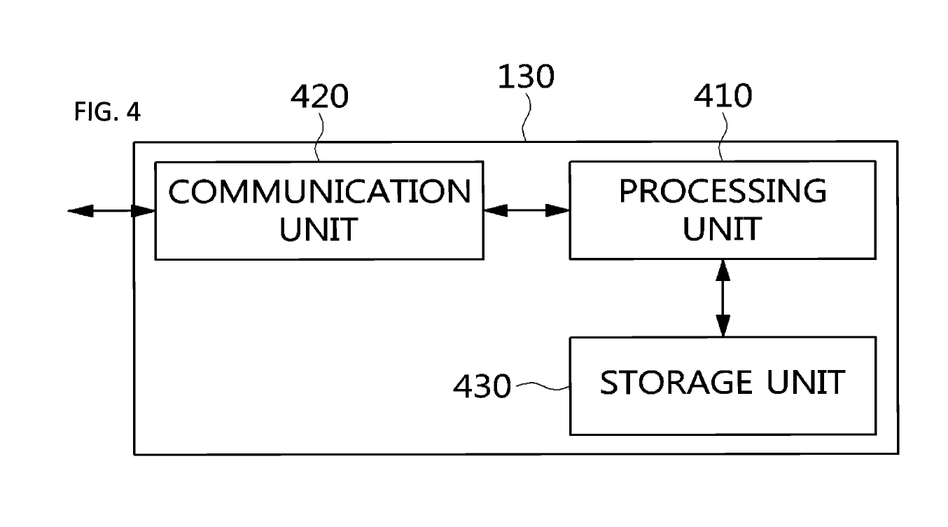

FIG. 4 is a configuration diagram of the customer node according to an embodiment.

The customer node 130 may include a processing unit 410, a communication unit 420, and a storage unit 430.

The processing unit 410 may process tasks required for the operation of the customer node 130. The processing unit 410 may execute code in the operations or steps of the processing unit 410, as will be described in connection with the embodiments.

The processing unit 410 may perform the generation and processing of data or information and may perform examination, comparison, determination, etc. related to data or information. In other words, the generation and processing of data or information and verification, comparison, and determination related to data or information in the embodiments may be performed by the processing unit 410.

For example, the processing unit 410 may perform encryption and/or decryption on data or information. The processing unit 410 may generate messages.

For example, the processing unit 410 may be at least one processor.

The communication unit 420 may receive data or information required for the operation of the customer node 130, and may send data or information required for the operation of the customer node 130.

The communication unit 420 may send data or information to other devices in a network and receive data or information from other devices. In other words, the transmission or reception of data or information in the embodiment may be performed by the communication unit 420.

For example, the communication unit 420 may be a networking chip, a networking interface, or a communication port.

The storage unit 430 may store the data or information required for the operation of the customer node 130. In an embodiment, the data or information of the customer node 130 may be stored in the storage unit 430.

For example, the storage unit 430 may be memory. The storage unit 430 may include an embedded storage medium such as RAM or flash memory, and may also include a removable storage medium such as a memory card.

The storage unit 430 may store at least one program. The processing unit 410 may execute at least one program. The processing unit 410 may read the code of at least one program from the storage unit 430, and may execute the read code.

The operations, functions and features of the processing unit 410, the communication unit 420, and the storage unit 430 of the customer node 130 will be described in detail later with reference to embodiments.

In the embodiments which will be described later, the following notation may be used in relation to entities, information, variables, etc.

MEⱼ: “MEⱼ” may denote a j-th main authentication entity. “MEⱼ” in a message may indicate the identifier of the j-th main authentication entity.

Pⱼ: “Pⱼ” may denote a j-th service-providing entity. “Pⱼ” in a message may indicate the identifier of the j-th service-providing entity.

Cᵢ: “Cᵢ” may denote an i-th customer node. “Cᵢ” in a message may indicate the identifier of the i-th customer node.

AΔB. “AΔB” may indicate that A is associated with B such that B is in controlling authority.

For example, “PᵢΔMEⱼ” may indicate that Pᵢ is associated with MEⱼ.

A∥B: “A∥B” may indicate A and B. “A∥B” may indicate that A and B are present and may also indicate concatenation of A and B. Alternatively, “A∥B” may indicate data having a predefined length in which data of A having a predefined length and data of B having a predefined length are concatenated.

Gⱼ: “Gⱼ” may denote a group of all associated entities of MEⱼ.

Gⱼ⁰: “G₁⁰” may denote a group of all non-associated entities of MEⱼ which knows the K_{G}^{j}.

AεB: “AεB” may indicate that A is a member of a set or group B.

For example, in order to represent a member of a set or a group, MEᵢεN(MEᵢ) or PⱼεGᵢ may be used.

K₀^{j}: “K₀^{j}” may be a time-based key at a 0-th time interval. K₀^{j} may be a commitment key. K₀^{j} may be used in a group of MEⱼ

Kᵢ^{j}: “Kᵢ^{j}” may be a time-based key at an i-th time interval. Kᵢ^{j} may be generated at the i-th time interval. Kᵢ^{j} may be used in the group of MEⱼ.

K_{A}^{j}: “K_{A}^{j}” may be a public key of a j-th entity A.

K_{ME}^{j}: “K_{ME}^{j}” may be a public key of MEⱼ.

K_{P}^{j}: “K_{P}^{j}” may be a public key of Pⱼ.

K_{C}^{j}: “K_{C}^{j}” may be a public key of Cⱼ.

K_{G}^{j}: “K_{G}^{j}” may be a group key generated by MEⱼ. K_{G}^{j} may be used in the group of MEⱼ.

K_{S}ⁱ: “K_{S}ⁱ” may be a session key at some time interval for Cᵢ.

E_{B}ⁱ(m): “E_{B}ⁱ(m)” may indicate that a message “m” is encrypted with a key K_{B}ⁱ. Alternatively, E_{B}ⁱ(m) may denote a message “m” encrypted with the key K_{B}ⁱ.

E_{ME}^{j}(m): “E_{ME}^{j}(m)” may indicate that a message “m” is encrypted with a key K_{ME}^{j}. Alternatively, “E_{ME}^{j}(m)” may denote a message “m” encrypted with the key K_{ME}^{j}.

V₀: “V₀” may be an index value for a 0-th time interval.

“Vᵢ” Vᵢ may be an index value for an i-th time interval.

T_{K}: “T_{K}” may be a k-th ticket at the i-th time interval. T_{K} may be generated at the i-th time interval.

Nᵢ: “Nᵢ” may be an i-th nonce in the message exchange of TAP.

H( ): “H( )” may be a one-way high entropy hash function.

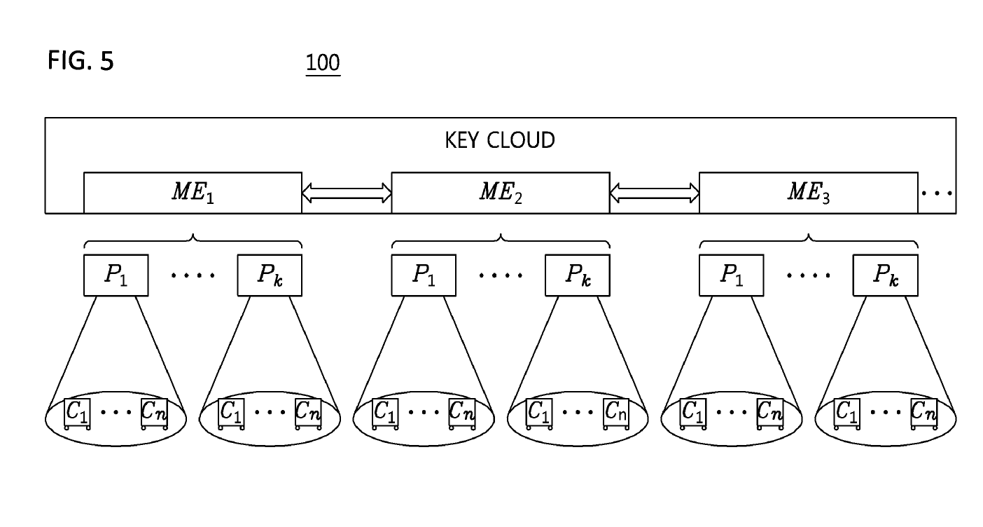

FIG. 5 illustrates the architecture of a system for providing a TAP according to an embodiment.

In a system 100 for providing a TAP, there are one or more main authentication entities 110. Also, there are one or more service-providing entities 120 and one or more customer nodes 130.

In FIG. 5, as the one or more main authentication entities, MEⱼ, ME₂ and ME₃ are shown.

The one or more main authentication entities may generate a key cloud.

Further, in FIG. 5, as the one or more service-providing entities associated with each ME, P₁ to Pₖ are shown for each ME.

Further, in FIG. 5, as the one or more customer nodes associated with each P, C₁ to Cₙ are shown for each P.

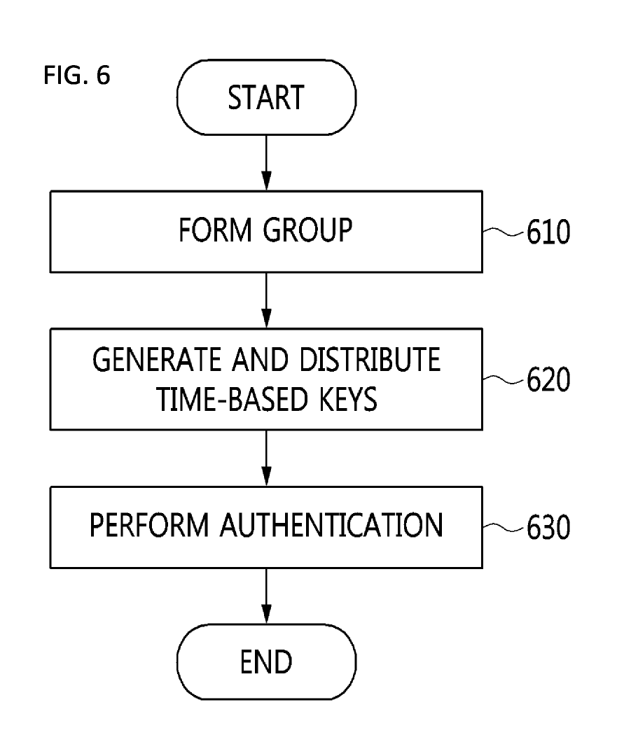

FIG. 6 is a flowchart showing an authentication method according to an embodiment.

Embodiments which will be described below may include three sub-innovation parts. The three sub-innovation parts may be 1) group formation, 2) generation and distribution of time-based keys, and 3) authentication procedure.

Simple sketches of the scheme proposed in the embodiments may be defined as in the following steps 610, 620 and 630.

At step 610, the formation of a group may be performed.

1.1 In order to establish the overall infrastructure for service and authentication, each ME of a network may form a group of communication entities. The communication entities may include 1) the ME itself, 2) service-providing entity P and 3) other MEs which neighbor the ME. The number of Ps and the number of other MEs may be one or more.

P may send a request to join a group of communication entities in the network to the ME.

At step 620, the generation and distribution of time-based keys may be performed.

2.1 Each ME may generate key generation information about time-based keys using group key encryption. The key generation information may include one or more generation arguments.

2.2 Each ME may broadcast the key generation information so that the members of the group receive the generation arguments. Each member of the group may receive the key generation information from the corresponding ME.

2.3 Each member of the group may generate a commitment key generator using the key generation information and an irreversible function g.

2.4 Each member of the group may generate a “keychain generator” using the commitment key generator and an irreversible function F. The length of the keychain generator may be L.

The keys may be generated using the irreversible function F in the reverse order of an order in which the keys are used.

At step 630, authentication may be performed.

In the chain of keys, an i-th key may be valid only for an i-th index. In other words, respective keys in the keychain may be valid for time intervals predefined for respective keys.

3.1 When a customer node C desires to join for an i-th time interval, the C may acquire a ticket encrypted with the i-th key.

3.2 The ME or P may authenticate the C using the ticket. The ME or P, which is a verifier for the ticket, may authenticate the C based on the keychain. The ME or P may verify the ticket by decrypting the ticket using the i-th key in the keychain. Here, the selected i-th key may be a key, corresponding to the time interval during which a service is provided to C, among the keys in the keychain.

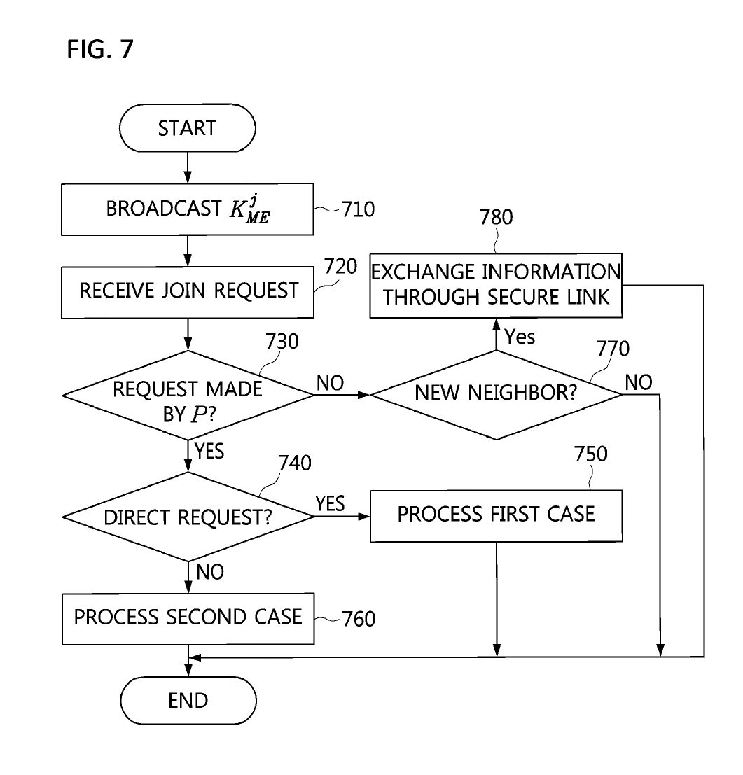

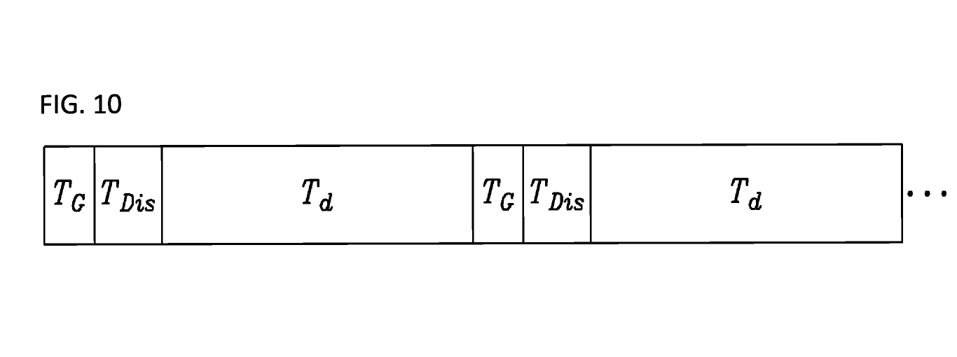

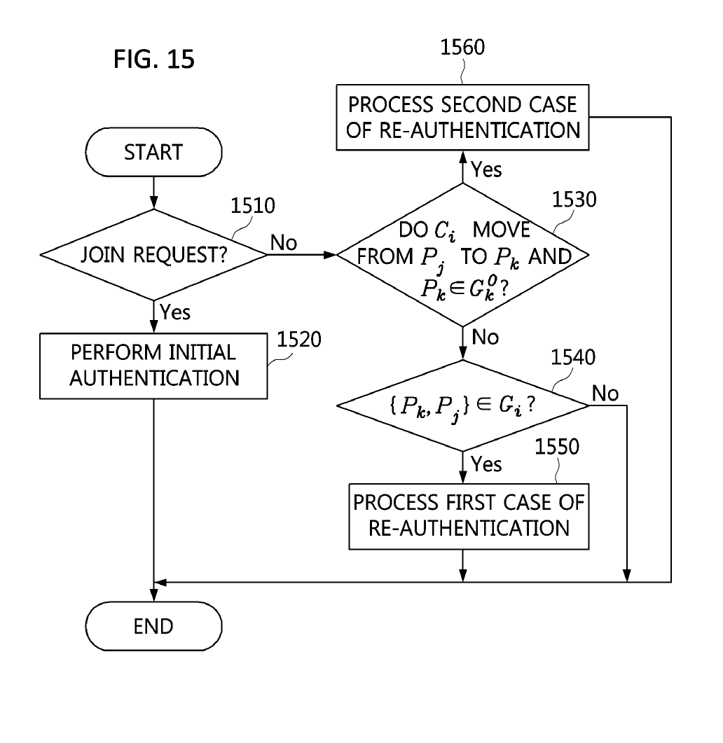

In the following embodiments, FIGS. 7 to 9 may relate to 1) the sub-innovation part for group formation. FIGS. 10 to 14 may relate to 2) the sub-innovation part for the generation and distribution of time-based keys. FIGS. 15 to 18 may relate to 3) the sub-innovation part for the authentication procedure.

Proposed Scheme for TAP

As described above, the scheme of the TAP may be composed of two major parts. The two major parts may be 1) a procedure for including Ps and neighboring MEs in a group of MEⱼ and 2) a procedure for initial authentication and re-authentication of the C.

In the following embodiments, the two major parts, together with a time-based key Kᵢ^{j}, will be described in detail.

However, to establish the overall infrastructure, the formation of a group and the management of a group key K_{G}^{j} may also be performed for respective system constraints and for respective requirements.

In the following embodiments, since the concept of a group key is used, it may be assumed that the members of the group are not time-synchronized with each other. In a tightly time-synchronized distributed system, the time-based key Kᵢ^{j} may replace the group key K_{G}^{j}. Such replacement may enable the overall system to be further simplified at the cost of the management of a synchronized clock.

Group Formation

Each MEⱼ may form a group Gⱼ. Gⱼ may include 1) the MEⱼ, 2) MEs (N(MEⱼ)) neighboring the MEⱼ, and 3) service-providing entities {PⱼΔMEⱼ} associated with the MEⱼ. Here, the MEⱼ may be a group leader.

Gⱼ may be defined as in the following Equation (1):

Gⱼ=MEⱼ∪N(MEⱼ)∪{PⱼΔMEⱼ} (1)

where N may denote a set of MEs in the neighborhood of the MEⱼ.

FIG. 7 is a flowchart showing a group formation method according to an embodiment.

At step 710, the MEⱼ may broadcast a public key of the MEⱼ. The Pᵢ may receive the public key of the MEⱼ via this broadcasting.

At step 720, the MEⱼ may receive a request to join the group of the MEⱼ.

At step 730, the MEⱼ may determine whether the join request was made by P, which is its neighbor. If the join request was made by the P, step 740 may be performed. If the join request was not made by the P, step 770 may be performed.

At the following steps 750 and 760, two schemes for associating the Pᵢ with the MEⱼ are respectively performed.

The service-providing entity Pᵢ, which requests to join the group, may associate the Pᵢ itself with the MEⱼ using any one of the two schemes. The two schemes may include a direct scheme based on a direct request made by the Pᵢ, and an indirect scheme based on an indirect request via the Pⱼ, which is another service-providing entity.

In the indirect scheme, the Pᵢ may be associated with the MEⱼ via the service-providing entity Pⱼ, which has already been associated with the MEⱼ.

At this time, since the Pⱼ has already been associated with the MEⱼ, the following Equation (2) may be satisfied.

PⱼεGᵢ (2)

At step 740, the MEⱼ may determine whether the join request is a direct request. The direct request may indicate the case where the Pᵢ sends its own join request. The indirect request may indicate the case where the Pⱼ forwards the join request originating from the Pᵢ. When the join request is the direct request, step 750 may be performed. When the join request is not the direct request, step 760 may be performed.

At step 750, the MEⱼ may process a first case. The first case may indicate the case where the Pᵢ falls within the communication range of the MEⱼ, and thus the Pᵢ directly sends the request to join the group to the MEⱼ. The MEⱼ may allow the Pⱼ, which has directly requested to join the group, to join the group.

At step 760, the MEⱼ may process a second case. The second case may indicate the case where the Pᵢ does not fall within the communication range of the MEⱼ, and thus the Pᵢ indirectly sends the request to join the group to the MEⱼ via Pⱼ. The second case may correspond to an indirect request. The MEⱼ may allow the Pᵢ, which has indirectly requested to join the group, to join the group.

At step 770, the MEⱼ may determine whether the join request was made by a new neighbor. If the MEⱼ determines that the join request was made by the new neighbor, step 780 may be performed.

At step 780, the MEⱼ may exchange information with the entity that made the join request through a secure link. For example, exchanged information may include the public key K_{ME}^{j} of the MEⱼ and may also include the public key of the entity that made the join request.

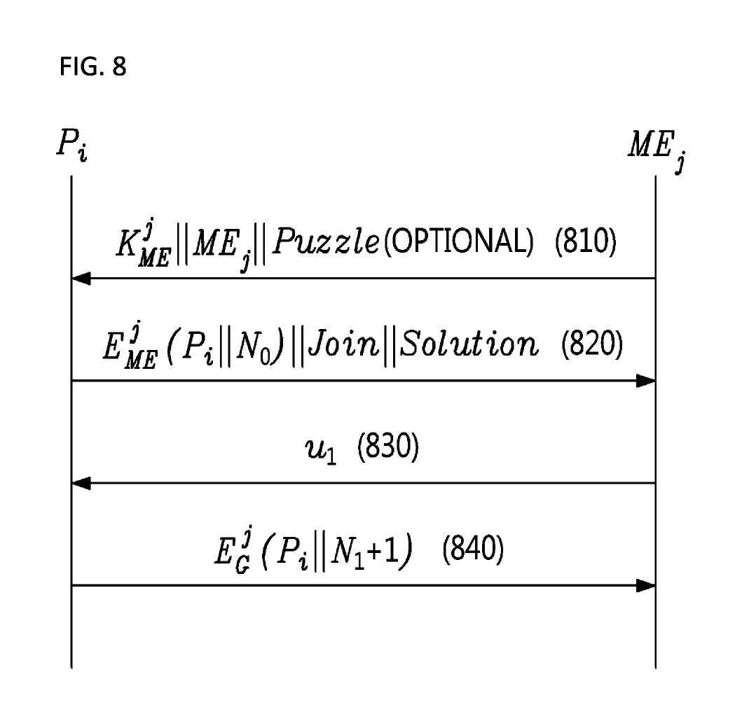

FIG. 8 is a flowchart showing a group formation method when the Pᵢ falls within the communication range of the MEⱼ according to an embodiment.

The embodiment, which will be described in detail with reference to FIG. 8, may correspond to a first case of the embodiment, described above with reference to FIG. 7. Step 810 may correspond to step 710. Step 820 may correspond to step 720. Steps 830 and 840 may correspond to step 750.

In an embodiment, the Pᵢ may fall within the communication range of the MEⱼ.

At step 810, the MEⱼ may send a broadcast message after every i-th time interval. The sending of the broadcast message may be optional.

The broadcast message may contain the information given by the following Equation (3):

k_{ME}^{j}∥MEⱼ∥Puzzle (3)

“Puzzle” may be used to acquire “Solution”, which will be described later.

The MEⱼ may broadcast the public key K_{ME}^{j} and Puzzle of the MEⱼ after every i-th time interval. Via the broadcasting, the Pᵢ may receive the public key K_{ME}^{j} and the Puzzle.

At step 820, the Pᵢ may send a joining message to the MEⱼ.

The joining message may contain the information given by the following Equation (4):

E_{ME}^{j}(Pᵢ∥N₀)∥Join∥Solution (4)

N₀ may be a nonce determined by the Pᵢ.

“Join” may indicate that the sent message is a joining message for requesting to join the group.

“Solution” may be a solution of “Puzzle” at step 810. “Puzzle” may be designed such that only a legitimate user is capable of finding a solution. A distributed denial of service (DDoS) attack may be avoided via “Puzzle” at step 810 and “Solution” at step 820.

The Pᵢ may send N₀, encrypted with the public key of the MEⱼ, to the MEⱼ. The MEⱼ may extract Pᵢ and N₀ by decrypting the information given in Equation (4) using the private key of the MEⱼ.

That is, when a first entity receives a message containing specific information from a second entity, and the information is encrypted with the public key of the first entity, the first entity may extract the information using its own private key. Hereinafter, it may be assumed that the extraction of information using the private key is performed after the reception of the message. A description related to the extraction of information using the private key may be omitted.

At step 830, the MEⱼ may send a challenge message to the Pᵢ.

The challenge message may contain information u₁.

The MEⱼ may send u₁ to the Pᵢ.

u₁ may be defined as in the following Equation (5):

u₁=E_{P}ⁱ(K_{G}^{j}∥N₀+1∥N₁∥Gⱼ∥KEY_{MSG}∥MEⱼ) (5)

u₁ may contain information N₀+1. Therefore, the challenge message may be a response to the challenge of the joining message at step 820.

N₁ may be a nonce determined by the MEⱼ.

Gⱼ may be the identifier of a group generated by the MEⱼ.

KEY_{MSG} may be key generation information required to generate a chain of keys.

By receiving u₁, the Pᵢ may generate a chain of keys using the key generation information KEY_{MSG}

KEY_{MSG} may be defined as in the following Equation (6):

Key_{MSG}=TABLE∥lookup(I,O)∥T_{d}∥T_{c}^{j}∥N₀^{j}∥L∥MODE (6)

KEY_{MSG} will be described in detail later.

At step 840, the Pᵢ may send a response message, responding to the challenge message, to the MEⱼ.

The response message may be checked using the information given by the following Equation (7):

E_{G}^{j}(Pᵢ∥N₁+1) (7)

The Pᵢ may encrypt Pᵢ and N₁+1 using K_{G}^{j} and may respond to the challenge by including N₁+1 in a response message.

That is, when the first entity receives a message containing specific information from the second entity, and the information is encrypted with the group key of the first entity, the first entity may extract the information using the group key. Hereinafter, it may be assumed that the extraction of information using the group key is performed after the reception of the message. A description related to the extraction of information using the group key may be omitted.

The MEⱼ may determine whether the response to the challenge has succeeded by checking whether the value of N₁+1 is correct. When the response to the challenge has failed, the MEⱼ may remove the Pᵢ from the group and may issue a new group key K_{G}^{j}.

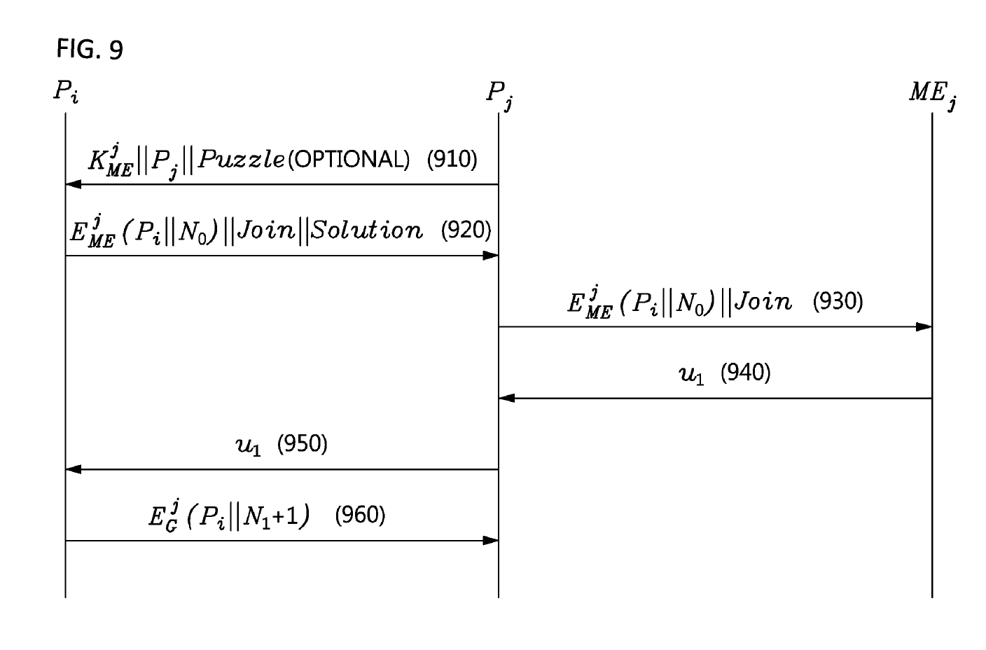

FIG. 9 is a flowchart showing a group formation method when the Pᵢ does not fall within the communication range of the MEⱼ according to an embodiment.

The embodiment which will be described with reference to FIG. 9 may correspond to the first case in the embodiment described above with reference to FIG. 7. Step 910 may correspond to step 710. Steps 920 and 930 may correspond to step 720. Steps 940, 950 and 960 may correspond to step 750.

In an embodiment, the Pᵢ may fall out of the communication range of the MEⱼ, and the Pⱼ may fall within the communication range of the MEⱼ.

At step 910, the Pⱼ may send a broadcast message after every i-th time interval. The sending of the broadcast message may be optional.

The broadcast message may contain the information given by the following Equation (8):

k_{ME}^{j}∥Pⱼ∥Puzzle (8)

“Puzzle” may be used to acquire “Solution”, which will be described later.

The Pⱼ may broadcast the public key K_{ME}^{j} and Puzzle of the MEⱼ after every i-th time interval. Via the broadcasting, the Pᵢ may receive the public key K_{ME}^{j} and the Puzzle of the MEⱼ.

At step 920, the Pᵢ may send a joining message to the Pⱼ.

The joining message may contain the information given by the following Equation (9):

E_{ME}^{j}(Pᵢ∥N₀)∥Join∥Solution (9)

N₀ may be a nonce determined by the Pᵢ.

“Join” may indicate that the sent message is a joining message for requesting to join a group.

“Solution” may be a solution of “Puzzle” at step 910. “Puzzle” may be designed such that only a legitimate user is capable of finding a solution. A DDoS attack may be avoided via “Puzzle” at step 910 and “Solution” at step 920.

The Pᵢ may send N₀, encrypted with the public key of the MEⱼ, to the Pⱼ.

At step 930, the Pⱼ may send a joining forward message to the MEⱼ. Alternatively, the Pⱼ may forward the joining message to the MEⱼ.

The joining forward message may contain at least a portion of the information of the joining message. For example, the joining forward message may contain the information given by the following Equation (10).

E_{ME}^{j}(Pᵢ∥N₀)∥Join (10)

The Pⱼ may forward N₀, encrypted with the public key of the MEⱼ, to the MEⱼ.

At steps 940 and 950, u₁ may sent from the MEⱼ to the Pᵢ.

At step 940, the MEⱼ may send a challenge message to the Pⱼ.

The challenge message may contain information u₁.

The MEⱼ may send u₁ to the Pⱼ.

u₁ may be defined in the following Equation (11):

u₁=E_{P}ⁱ(K_{G}^{j}∥N₀+1∥N∥Gᵢ∥KEY_{MSG}∥MEⱼ) (11)

u₁ may include N₀+1. Therefore, the challenge message may be a response to the challenge of the joining message at step 920.

N₁ may be a nonce determined by the MEⱼ.

KEY_{MSG} may be key generation information required to generate a chain of keys.

KEY_{MSG} may be defined as in the following Equation (12):

Key_{MSG}=TABLE∥lookup(I,O)∥T_{d}∥T_{c}^{j}∥N₀^{j}∥L∥MODE (12)

KEY_{MSG} will be described in greater detail later.

At step 940, the Pⱼ may send a challenge forward message to the Pᵢ. Alternatively, the Pⱼ may forward a challenge message to the Pᵢ.

The challenge forward message may contain the above-described information u₁.

Pⱼ may forward u₁ to the Pᵢ.

By receiving u₁, the Pᵢ may generate a chain of keys using the key generation information KEY_{MSG}.

At step 950, the Pᵢ may forward u₁ to the Pⱼ.

By receiving u₁, the Pᵢ may generate the keychain using the key generation information KEY_{MSG}.

At step 960, the Pᵢ may send a response message, responding to the challenge message, to the Pⱼ.

The response message may contain the information given by the following Equation (13):

E_{G}^{j}(Pᵢ∥N₁+1) (13)

Pᵢ may encrypt Pᵢ and N₁+1 using K_{G}^{j} and may respond to the challenge by including N₁+1 in the response message.

Pⱼ may determine whether the response to the challenge has succeeded by checking whether the value of N₁+1 is correct. When the response to the challenge has failed, the Pⱼ may inform the MEⱼ that the Pᵢ should be removed from the group. When the MEⱼ is informed that the Pᵢ should be removed from the group, the MEⱼ may remove the Pᵢ from the group and may issue a new K_{G}^{j}.

In addition to the associated service-providing entities, all intermediate neighbors N(MEⱼ) of the MEⱼ may also be the members of a group Gⱼ.

MEᵢ may be defined in the following Equation (14):

MEᵢεN(MEⱼ) (14)

All MEᵢ may share K_{G}^{j} and h(MEⱼ) with associated service-providing entities {PᵢΔMEᵢ}.

On the other hand, all MEᵢ may be regarded as group observers Gⱼ^{o}. The members of Gⱼ^{o} may not participate in key generation managed by the MEⱼ. Further, for Gⱼ and Gⱼ^{o}, the following Equation (15) may be satisfied.

Gⱼ∩Gⱼ^{o}=Ø (15)

Time-Based Key

FIG. 10 illustrates a time frame related to the generation and usage of time-based keys according to an embodiment.

In FIG. 10, the illustration is made such that time passes in the direction from left to right. For example, after time T_{G} has passed, the interval of T_{Dis} begins. After T_{Dis} has passed, the interval of T_{d} begins.

The time frame may be divided into three periods. The three periods may correspond to T_{G}, T_{Dis}, and T_{d}. T_{G} may be the time required for key generation. T_{Dis} may be the time required for key distribution. T_{d} may be a valid time for a commitment key K₀^{j}.

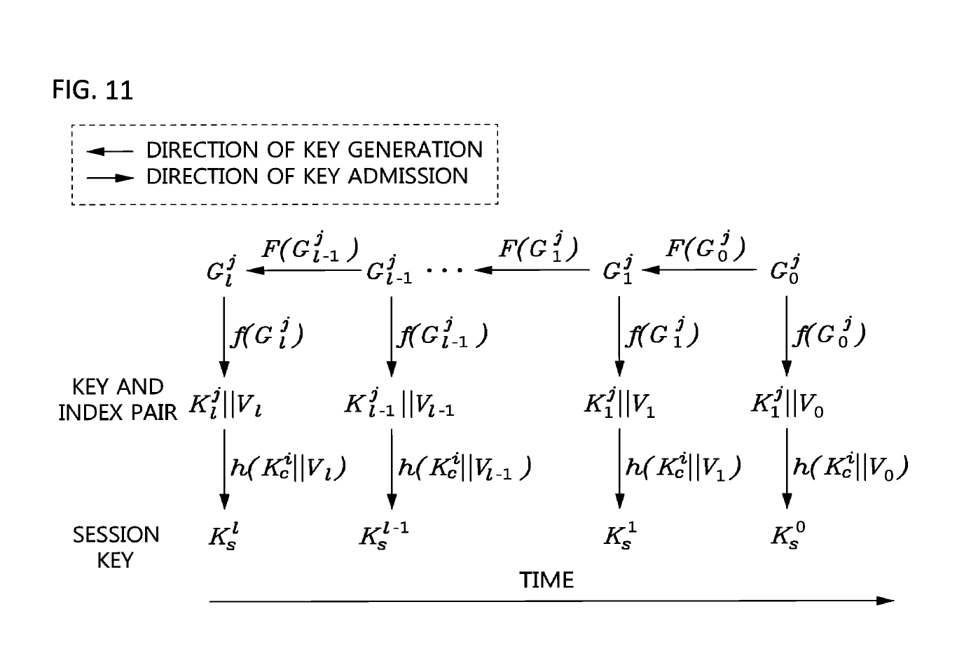

FIG. 11 illustrates the generation and admission of time-based keys in relation to the passage of time according to an example.

All members of Gⱼ may generate the commitment key K₀^{j} using key generation information KEY_{MSG}.

As described above with reference to FIGS. 8 and 9, at the time at which a certain user joins the group as a member, the key generation information KEY_{MSG} may be sent to the member of the group in the state in which the key generation information has been encrypted using the public key of the member. Via this sending, KEY_{MSG} may be shared among the members of the group.

After every time interval T_{d}, the MEⱼ may broadcast the key generation information KEY_{MSG} to all members of Gⱼ. The broadcasted KEY_{MSG} may be encrypted with the group key K_{G}^{j} of the group. Alternatively, in the case of a time-synchronized system, the broadcasted KEY_{MSG} may be encrypted with a time-based key Kₗ^{j}. Here, Kₗ^{j} may be the final key of a keychain.

The key generation procedure and all characteristics related thereto may be controlled by the MEⱼ, which is the leader of the group.

The key generation information KEY_{MSG} may be defined as in the following Equation (16):

KEY_{MSG}=lookup(I,O)∥T_{d}∥T_{c}ⁱ∥N₀^{j}∥L∥MODE (16)

The key generation information KEY_{MSG} may consist of several pieces of information.

KEY_{MSG} may include information such as lookup, T_{d}, T_{c}^{j}, N₀^{j}, L, and MODE information.

A secret table may be shared among all members involved in step 830. Further, the secret table may be shared among all members involved in step 940. In other words, the table may be shared so that data may be used in common by all entities involved in the joining.

I may denote an index for selecting a value from the secret table. O may denote an offset for selecting a value from the secret table. The values of I and O may be randomly determined by the MEⱼ.

“lookup(I, O)” may be a value at the location determined by the index I and the offset O of the secret table. A specific value may be selected from the secret table using the index I and the offset O. For example, lookup(I, O) may indicate the value extracted from the secret table using the index I and the offset O.

T_{d} may be a valid time duration for the commitment key K₀^{j}.

T_{c}^{j} may be a time on the MEⱼ when the MEⱼ broadcasts KEY_{MSG}.

L may indicate the length of the chain of keys (keychain). Alternatively, L may be the time duration for the keychain.

The number of time-based keys in the keychain may be L. T_{d} may be divided into L time intervals.

N₀^{j} may be a nonce determined by the MEⱼ.

MODE may indicate a key retrieval mode. The elements of the above-described KEY_{MSG} will be described in detail later.

Key Generation and Distribution Procedure

After successful distribution of KEY_{MSG}, all members of Gᵢ may perform the following tasks.

Each member may generate a commitment key generator G₀^{j} and a chain of keys using the key generation information KEY_{MSG}.

1) The member may generate the commitment key generator G₀^{j} by running a function g.

G₀^{j} may be defined as in the following Equation (17):

G₀^{j}=g(lookup(I,O),T_{d},N₀^{j}) (17)

The function g may be defined as in the following Equation (18):

g=H(lookup(I,O)⊕T_{d})⊕N₀^{j} (18)

“⊕” may be an exclusive OR (XOR) operator.

An irreversible function F may be defined as in the following Equation (19):

F=H(Gᵢ^{j}) (19)

When i>0, Gᵢ^{j} may be a generator of the key Kᵢ^{j}.

“i” may indicate the order in which keys are generated. Further, i may denote the reverse order of the order in which keys are used, or the reverse order of the order of time intervals during which keys are valid.

2) F may take G₀^{j} as an input argument and the member may generate a keychain having a length of L using F.

When the keychain is generated, F may be used, as given by the following Equation (20):

F(G₀^{j})=G₁^{j},F(G₁^{j})=G₂^{j} . . . F(Gₗ₋₁^{j})=Gₗ^{j} (20)

The value of I may be identical to that of L.

When the commitment key generator of the group is the input of the irreversible function F, the output of the irreversible function may be the generator of the key that is finally used, among the keys.

In other words, F may be defined as in the following Equation (21):

F(Gₖ^{j})ⁱ=Gₖ₊ᵢ^{j} (21)

When the generator of a k+1-th key is the input of the irreversible function F, the output of the irreversible function F may be the generator of a k-th key.

3) All members of Gᵢ may generate vectors for index V and key K using another irreversible function ƒ.

The irreversible function ƒ may be defined as in the following Equation (22):

ƒ=H(Gᵢ^{j})⊕N₀^{j}∥H(i)⊕N₀^{j} (22)

Further, a pair of index V and key K may be defined as in the following Equation (23):

ƒ(G₀^{j})=(K₀^{j}∥V₀),ƒ(G₁^{j})=(K₁^{j}∥V₁), . . . ƒ(Gₗ^{j})=(Kₗ^{j}∥Vₗ)→K∥V (23)

The pair of index V and key K may be generated based on the irreversible functions F and ƒ.

In Equations (22) and (23), “H(Gᵢ^{j})⊕N₀^{j}” in a former part may correspond to key Kᵢ^{j}, and “H(i)⊕N₀^{j}” in a latter part may correspond to index V. The key Kᵢ^{j} may be generated based on the key generator Gᵢ^{j} and the nonce N₀^{j}. The index V may be generated based on i and the nonce N. As shown in FIG. 11, referring to Equations (17) to (22), the commitment key K₀^{j} of the group and the time-based keys K₁^{j} to Kₗ^{j} may be generated based on predefined values. The predefined values may be one or more of 1) the commitment key generator G₀^{j}, 2) the valid time T_{d} for the commitment key K₀^{j}, and 3) the nonce N₀^{j} determined by the MEⱼ.

Vector V and vector K may be defined as in the following Equation (24):

V={V₀,V₁, . . . ,Vₗ},K={K₀^{j},K₁^{j}, . . . ,Kₗ^{j}} (24)

The members may issue an i-th key used to encrypt a ticket Tₖ during an i-th time interval. Since the keys are disclosed in reverse order, it may be impossible for an intruder to generate keys to be used in the future.

On the other hand, the index vector V may perform an indexing function to retrieve a key, and Vᵢ may correspond to an i-th time interval. For example, the following Equation (25) may be satisfied.

F(G₀^{j})ⁱ=Gᵢ^{j} [symbol] ƒ(Gᵢ^{j})=(Kᵢ^{j},Vᵢ) (25)

In addition to the time-based keys (for ticket encryption), the MEⱼ may generate a unique session key K_{S}^{k}, which is dependent on information about time and customer node C_{K}, for verified Cₖ and Pⱼ.

K_{S}^{k} may be defined as in the following Equation (26):

K_{S}^{k}=H(Kᵢ^{j}∥H(K_{C}^{k}) (26)

The session key K_{S}^{k} may be generated based on the time-based key Kᵢ^{j} and the public key K_{C}^{k} of the customer node C_{K}.

T_{R} may be a valid time for K_{S}^{k}. T_{R} may be defined as in the following Equation (27):

T_{R}=lᵢ−L (27)

lᵢ may be a system time during the i-th time interval, in which the ticket and the session key were issued. L may be the time duration of the keychain.

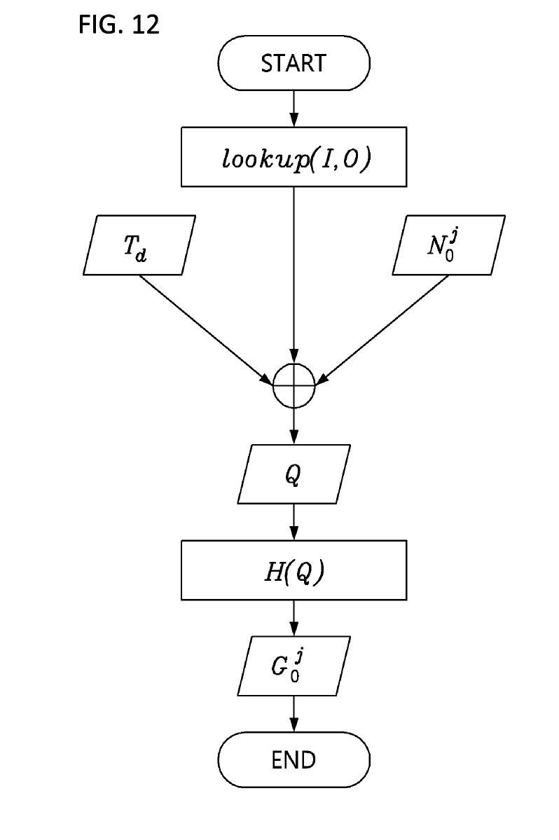

FIG. 12 illustrates the structure of a function g according to an example.

FIG. 12 may illustrate the structure of the function g, described above with reference to Equation (18), as a drawing.

In FIG. 12, a symbol such as a square may indicate the operation of a function or the like. A parallelogram may indicate an input value or an output value or may indicate a variable or data used as the input value or the output value. “⊕” may be an exclusive OR (XOR) operator.

In FIG. 12, Q may indicate “lookup(I, O)⊕T_{d}⊕N₀^{j}”.

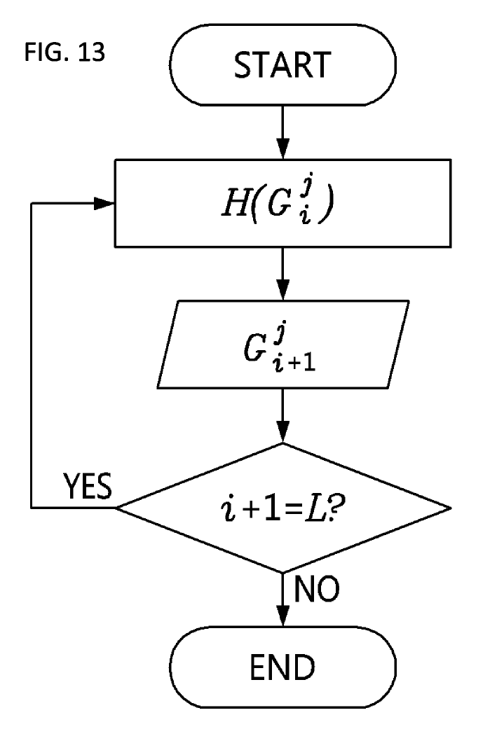

FIG. 13 illustrates the structure of a function F according to an example.

FIG. 13 may illustrate the structure of the function F, described above with reference to Equations (19), (20), and (21), as a drawing.

In FIG. 13, a symbol such as a square may indicate the operation of a function or the like. A parallelogram may indicate an input value or an output value or may indicate a variable or data used as the input value or the output value. A rhombus may indicate a conditional branch based on the results of a comparison.

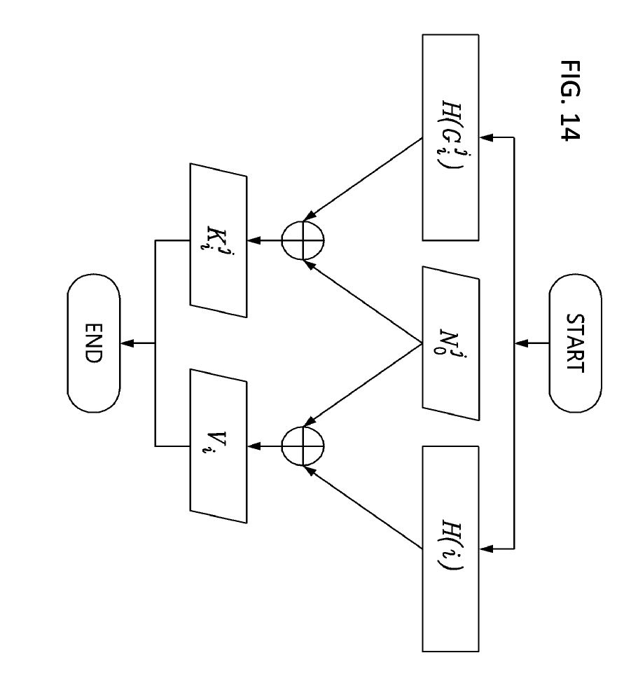

FIG. 14 illustrates the structure of a function ƒ according to an example.

FIG. 14 may illustrate the structure of the function ƒ, described above with reference to Equations (22) and (23), as a drawing.

In FIG. 14, a symbol such as a square may indicate the operation of a function or the like. A parallelogram may indicate an input value or an output value or may indicate a variable or data used as the input value or the output value. “0” may be an exclusive OR (XOR) operator.

Retrieval Modes for “Time-Based Ticket Encryption Keys”

The key retrieval modes may depend on the structure of a ticket, and the structure of the ticket may be determined by the requirements and constraints of the system 100. In the following embodiments, three different key retrieval modes, namely a first mode, a second mode, and a third mode, are individually described.

Structure of Ticket

The structure of an authentication ticket may depend on a selected mode.

In the first mode, the structure of a ticket Tₖ may be given by the following Equation (28):

Eᵢ^{j}=(Cₖ∥Kₛⁱ∥Vᵢ∥Profile∥H_{head})∥E_{G}^{j}(Cₖ∥Vᵢ∥H(Gᵢ)∥H(K_{C}^{k})) (28)

In the second mode, the structure of the ticket may be given by the following Equation (29):

Eᵢ^{j}(Cₖ∥Kₛⁱ∥Vᵢ∥Profile∥H_{head})∥E_{G}^{j}(Cₖ∥(Tₜ)∥H(Gᵢ)∥H(K_{C}^{k})) (29)

In the third mode, the structure of the ticket may be given by the following Equation (30):

Eᵢ^{j}(Cₖ∥Kₛⁱ∥Vᵢ∥Profile∥H_{head})∥E_{G}^{j}(Cₖ∥VᵢH_{head}∥Vector_{Hash}∥H(K_{C}^{k})) (30)

As defined in Equations (28), (29) and (30), the ticket may be divided into a first part corresponding to a first half and a second part corresponding to a second half. In other words, the ticket may include the first part and the second part.

The first part and the second part may be encrypted with different keys. For example, the first part may be encrypted with the time-based key Kᵢ^{j}. The second part may be encrypted with the group key K_{G}^{j} of the MEⱼ.

The first part and the second part of the ticket may be individually derived based on information specific to Cₖ.

For the first mode and the second mode, the first part of the ticket may have a single selective field H_{head}. The first part of the ticket may be identical regardless of the mode.

The second part of the ticket may be dependent on the mode. The second part of the ticket may differ depending on the mode.

The second part may include information used to determine the time-based key Kᵢ^{j} to decrypt the first part, which is the first half.

The first part of the ticket may be used to verify Tₖ.

First Mode

The MEⱼ may append an index value Vᵢ to Tₖ. Tₖ may include the index value Vᵢ.

A ticket verifier may compare Vᵢ of Tₖ with a vector V generated by the ticket verifier itself. A match of Vᵢ at the i-th place of V may mean that the ticket Tₖ may be decrypted with the key Kᵢ^{j}, which was generated by the ME, during the i-th time interval. In other words, Vᵢ in the second part of the ticket Tₖ may indicate the time interval corresponding to the key in the keychain that was used in the decryption of the first part of the ticket Tₖ.

Therefore, the ticket verifier may determine the time-based key Kᵢ^{j}, which is to be used to decrypt the first part of the ticket Tₖ, using Vᵢ in the second part of the Tₖ, and may decrypt the first part using the determined time-based key Kᵢ^{j}.

In other words, information about at least a portion (i.e. the first part) of the ticket Tₖ may be decrypted using the time-based key Kᵢ^{j}, which is valid for a predefined time interval.

Second Mode

The MEⱼ may append a ticket issuing time Tₜ to the ticket Tₖ.

The ticket verifier may verify whether the ticket issuing time Tₜ falls within the range given by the following Equation (31):

$$[ \vert {T}_{c}^{j} - {T}_{t} \vert * \frac{{T}_{d}}{L} - {ε}_{updated} , \vert {T}_{c}^{j} - {T}_{t} \vert * \frac{{T}_{d}}{L} + {ε}_{updated} ] \qquad ( 31 )$$

where T_{c}^{j} may denote the current time of the ticket verifier.

ε₀ may denote the initial value of a time drift ε. ε₀ may be calculated using the following Equation (32):

ε₀=|T_{c}ⁱ−T_{c}^{j}| (32)

Upon each successful retrieval of Kᵢ^{j}, the value of ε may be updated as ε_{updated}, as shown in the following Equation (33):

ε_{updated}=w₀*εₚᵣₑᵥᵢₒᵤₛ+w₁*ε_{current} (33)

where ε_{updated} may be the updated value of ε. ε_{current} may be the current value of ε. εₚᵣₑᵥᵢₒᵤₛ may be the previous value of ε.

w₀ may be defined as in the following Equation (34):

$${W}_{o} = 1 - \frac{{T}_{c}^{j} + {T}_{t}}{{T}_{d}} \qquad ( 34 )$$

where w₁ may be defined as in the following Equation (35):

$${W}_{1} = \frac{{T}_{c}^{j} + {T}_{t}}{{T}_{d}} \qquad ( 35 )$$

Third Mode

All members of a group Gᵢ may generate a hash tree. The leaf nodes of the hash tree may be index values from an index vector V.

The MEⱼ may append the index value Vᵢ and hash values Vector_{Hash} to the ticket Tₖ. The number of hash values may be log₂|V|.

Vector_{Hash} may have the values of nodes selected in the hash tree. By means of Vector_{Hash}, an index search having a complexity of O(1) may be performed, and hash tree reconstruction having a complexity of O(log) may be performed. In this case, the total number of hash operations may be log₂|V|.

An algorithm for the index search may be executed through the following steps 1) to 5).

1) First, a hash tree may be reconstructed and the head node of the hash tree may be confirmed.

2) The index search may start at the head node. The index search may be performed in the direction from the head node to lower nodes.

3) Appended values may be ignored, and the search may be performed to follow the reconstructed nodes.

4) The search may reach the level of log₂|V|−1.

5) Now, at the final level, the appended value, which is the index value, may be selected.

The third mode may be suitable for a very long keychain.

H_{head} may be the head node of the hash tree. The head node may be optionally included in the ticket Tₖ. The head node may ensure that the ticket Tₖ has been generated by a trusted group member.

Authentication Procedure

Cᵢ may be authenticated through three different schemes. When the Cᵢ joins the system, the Cᵢ may undergo an initial authentication procedure.

When moving from the area of one service-providing entity Pⱼ to the area of another service-providing entity Pᵢ, the Cᵢ may be re-authenticated using an authentication ticket Tₖ. the Cᵢ may acquire Tₖ during an initial authentication procedure.

FIG. 15 is a flowchart showing an authentication procedure according to an example.

Step 630, described above with reference to FIG. 6, may include steps 1510, 1520, 1530, 1540, 1550 and 1560.

At step 1510, when the request from the Cᵢ is a join request, step 1520 may be performed. When the request from the Cᵢ is not a join request, step 1530 is performed.

At step 1520, initial authentication may be performed.

At step 1530, when the Cᵢ moves from Pⱼ to Pₖ, step 1540 may be performed when Pₖ is not a member of Gₖ⁰. When the Cᵢ moves from Pⱼ to Pₖ, step 1560 may be performed when Pₖ is a member of Gₖ⁰.

At step 1540, when Pₖ and Pⱼ are members of Gᵢ, step 1550 may be performed.

At step 1550, a first case of re-authentication may be processed.

At step 1560, a second case of re-authentication may be processed.

Initial Authentication Procedure

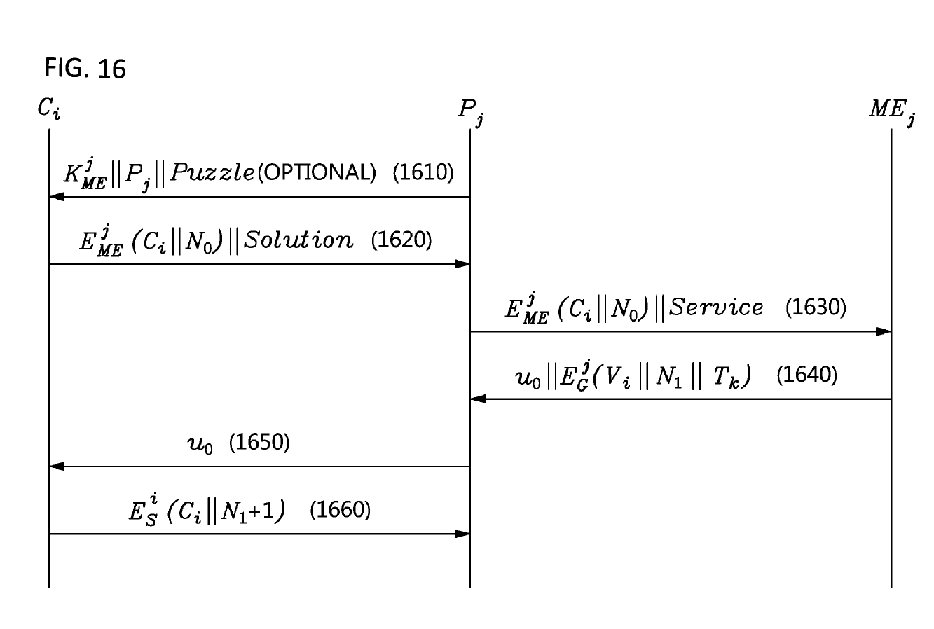

FIG. 16 is a flowchart showing an initial authentication method according to an embodiment.

Step 1520, described above with reference to FIG. 15, may include the following steps 1610, 1620, 1630, 1640, 1650, and 1660.

When the public key of the MEⱼ is broadcasted, the Pⱼ may receive the broadcasted pubic key of the MEⱼ. If the Cᵢ receives multiple broadcast messages, the Cᵢ may continue to perform an authentication procedure with the first Pⱼ. The initial authentication procedure may be performed through the following steps.

At step 1610, the Pⱼ may send a broadcast message after every i-th time interval.

The broadcast message may include the information given by the following Equation (36):

k_{ME}^{j}∥Pⱼ∥Puzzle (36)

“Puzzle” may be used to acquire “Solution” which will be described later.

Pⱼ may broadcast the public key K_{ME}^{j} and puzzle of the MEⱼ after every i-th time interval.

When the Cᵢ receives the broadcast message, the Cᵢ may send a service request message to the Pⱼ at step 1620. By means of the service request message, the service request may be sent from the Cᵢ to the Pⱼ.

The service request message may include the information given by the following Equation (37):

E_{ME}^{j}(Cᵢ∥N₀)∥Solution (37)

“Solution” may be a solution of “Puzzle” at step 1610. “Puzzle” may be designed such that only a legitimate user is capable of finding a solution. A DDoS attack may be avoided via “Puzzle” at step 1610 and “Solution” at step 1620.

N₀ may be a nonce determined by the Cᵢ.

The Cᵢ may send N₀, encrypted with the public key of the MEⱼ, to the Pⱼ.

At step 1630, the Pⱼ may send an authentication request message for the service request message to the MEⱼ. By means of the authentication request message, the service request from Cᵢ may be forwarded to the MEⱼ through the Pⱼ.

The authentication request message may include the information given by the following Equation (38):

E_{ME}^{j}(Cᵢ∥N₀)∥Service (38)

“Service” may denote a service requested by the Pᵢ. “Service” may be a flag indicating that the MEⱼ is requested to verify the Cᵢ.

When the MEⱼ receives the authentication request message, the MEⱼ may retrieve the profile of the Cᵢ from the database using the identifier of the Cᵢ included in the authentication request message.

When the Cᵢ is eligible for the requested service, the MEⱼ may confirm the authorization of services from the profile. Further, when the Cᵢ is eligible for the requested service, the MEⱼ may retrieve the public key of the Cᵢ and may send the ticket.

At step 1640, the MEⱼ may send an authentication response message to the Pⱼ.

The authentication response message may include the information given by the following Equation (39):

u₀∥E_{G}^{j}(Vᵢ∥N₁∥Tₖ) (39)

The MEⱼ may send u₀ to the Pᵢ and may also send the ticket Tₖ, encrypted with the group key K_{G}^{j} of the MEⱼ, the index value Vᵢ, and N₁ to the Pⱼ.

u₀ may be defined in the following Equation (40):

u₀=E_{C}ⁱ(Pⱼ∥N₀+1∥N₁∥Tₖ∥T_{R}∥Kₛⁱ) (40)

N₁ may be a nonce determined by the MEⱼ. N₁ may be a challenge for the Cᵢ.

N₀+1 may be a response to the challenge of the service request message at step 1620 and the authentication request message at step 1630.

Tₖ may be a time-based ticket.

T_{R} may be a valid time for K_{S}ⁱ.

As defined in Equations (28), (29) and (30), Tₖ may include the information given by the following Equation (41):

Eᵢ^{j}(Cₖ∥Kₛⁱ∥Vᵢ∥Profile∥H_{head}) (41)

“Profile” may denote the profile of the Cᵢ.

When the authentication response message is sent to the service-providing entity Pⱼ, the Pⱼ may retrieve the profile of the Cᵢ and session key K_{S}ⁱ from the information of Tₖ included in the authentication response message.

At step 1650, the Pⱼ may send a service challenge message to the Cᵢ. The service challenge message may include u₁.

The service challenge message may be a response to the service request at step 1620. Further, u₀ of the service challenge message may contain the information of the ticket Tₖ issued by the MEⱼ.

The Pⱼ may forward u₀ to the Cᵢ.

Here, if the service-providing entity Pⱼ cannot fulfill the requested service due to resource limitations, the Pⱼ may send a “Limited” message to the Cᵢ at step 1650. Here, the sent “Limited” message may include the information given by the following Equation (42):

u₀∥Limited (42)

“Limited” may mean that the requested service cannot be satisfied due to resource limitations.

When the “Limited” message is sent to the Cᵢ, the Cᵢ may continue to exchange messages with the Pⱼ, or may connect to another service-providing entity using the ticket allotted thereto.

The service request message at step 1620 and the authentication request message at step 1630 may include N₀. Further, u₁ in the authentication response message at step 1640 and in the service response message at step 1650 may include N₀+1. Therefore, the service request message at step 1620 and the authentication request message at step 1630 may be challenges, and the authentication response message at step 1640 and the service challenge message at step 1650 may be responses to the challenges.

The Cᵢ may verify the corresponding challenge using N₀+1. After the challenge has been verified, the Cᵢ may accept the ticket Tₖ.

The service challenge message may include information about the ticket Tₖ, issued by the MEⱼ that authenticates the Cᵢ, and Cᵢ may use the ticket Tₖ for subsequent re-authentication.

At step 1660, the Cᵢ may send a service response message to the service challenge message to the Pⱼ.

The service response message may include the information given by the following Equation (43):

Eₛⁱ(Cᵢ∥N₁+1) (43)

The service response message may include N₁+1. Therefore, the service response message may be a response to the challenge of the authentication response message at step 1640 and the service challenge message at step 1650.

The Pⱼ may verify the challenge using N₁+1. After the challenge has been verified, the Pⱼ may start providing the service. If the challenge is not verified, the Pⱼ may halt the service, and may mark the ticket Tₖ as a void ticket.

First Re-Authentication Procedure

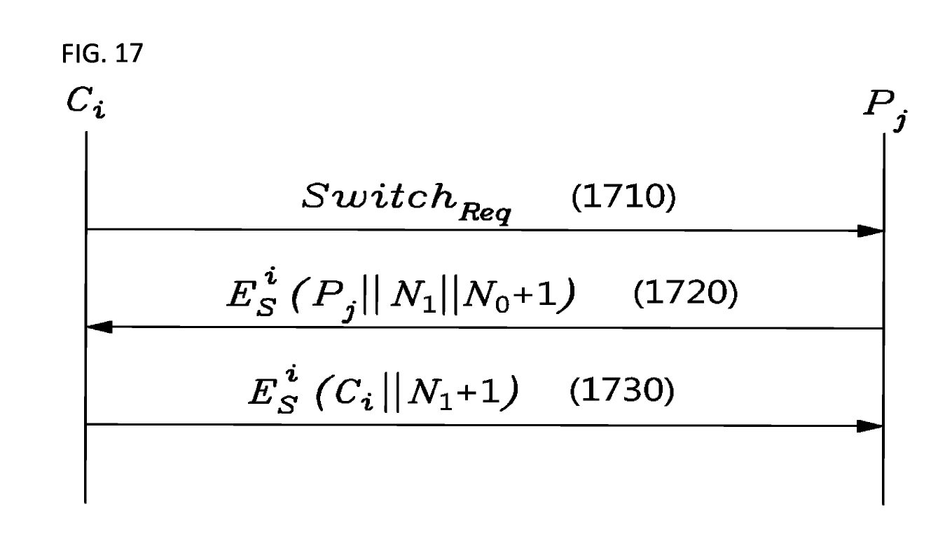

FIG. 17 is a flowchart showing a first case of re-authentication according to an example.

Step S1550, described above with reference to FIG. 15, may include the following steps 1710, 1720 and 1730.

The authenticated customer node Cᵢ may move from Pₖ to Pⱼ. For Pₖ and Pⱼ, the following Equation (44) may be satisfied.

{Pₖ,Pⱼ}εGᵢ (44)

The Pₖ and Pⱼ may be members of Gᵢ.

At step 1710, the customer node Cᵢ may send a switch request message Switch_{Req} to the Pⱼ. A changed service request may be sent from Cᵢ to Pⱼ via the switch request message.

“Switch_{Req}” may indicate that the sent message is a message requesting the customer node Cᵢ to switch the service-providing entity that provides the service.

The switch request message may be configured as shown in the following Equation (45):

Switch_{Req}=E_{S}ⁱ(Cᵢ∥N₀)∥Tₖ∥h(MEᵢ) (45)

N₀ may be a nonce determined by the Cᵢ.

The Pⱼ may derive the ticket Tₖ by decrypting information in the switch request message using K_{S}ⁱ.

The switch request message may include the information about Tₖ for re-authentication of Cᵢ.

As defined in Equations (28), (29), and (30), Tₖ may contain information about the K_{S}ⁱ. The Pⱼ may generate K_{S}ⁱ by decrypting Tₖ, and may determine, using K_{S}ⁱ, whether Cᵢ is eligible for further services.

The Pⱼ may receive multiple switch requests from the same Cᵢ. The multiple switch requests may have a similar nonce. Such multiple switch requests may indicate malicious users.

At step 1720, the Pⱼ may send a switch challenge message to the switch request message to the Cᵢ. The switch challenge message may include the information given by the following Equation (46):

Eₛⁱ(Pⱼ∥N₁∥N₀+1) (46)

The switch challenge message may include information N₀+1. Therefore, the switch challenge message may be a response to the challenge of the switch request message at step 1710.

N₁ may be a nonce determined by the Pⱼ. The switch challenge message may be a challenge for the Cᵢ. N₁, which is the challenge for the Cᵢ, may be encrypted with the session key K_{S}ⁱ of the group.

At step 1730, the Cᵢ may send a switch response message for the switch challenge message to the Pⱼ. The switch response message may be a response to the changed service request at step 1710.

The switch response message may include the information given by the following Equation (47):

Eₛⁱ(Cᵢ∥N₁+1) (47)

The switch response message may include information N₁+1. Therefore, the switch response message may be the response to the challenge of the switch challenge message at step 1720.

The Pⱼ may extract N₁+1 from the switch response message using Kₛⁱ, and may verify the challenge using N₁+1.

After the challenge has been verified, the Pⱼ may provide a service to the Cᵢ.

Unless the challenge is verified, the Pⱼ may halt the service and may mark the ticket Tₖ as a void ticket.

Second Re-Authentication Procedure

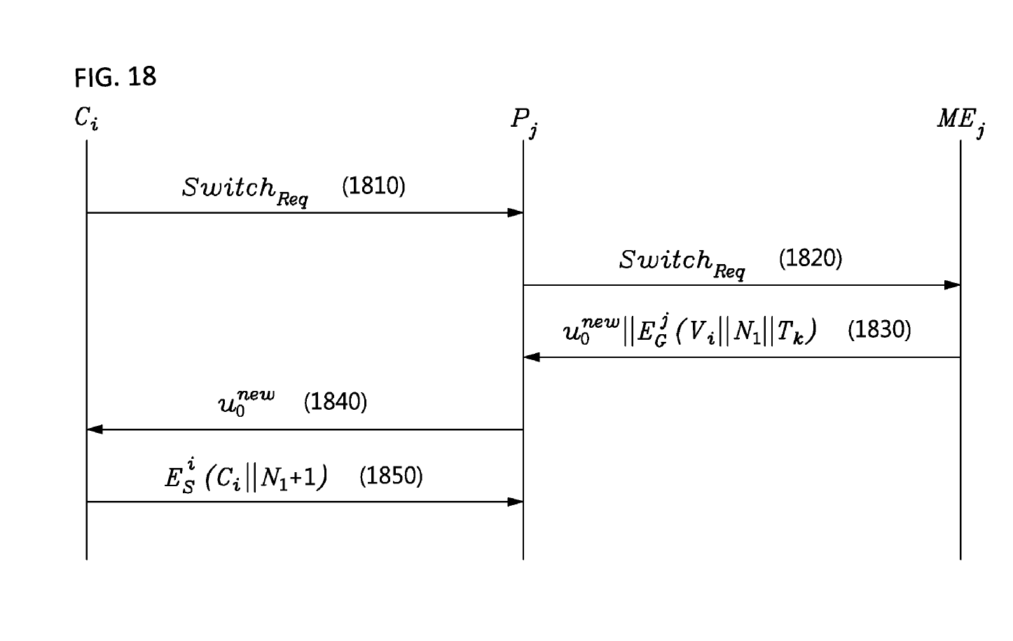

FIG. 18 is a flowchart showing a second case of re-authentication according to an example.

Step 1560, described above with reference to FIG. 15, may include the following steps 1810, 1820, 1830, 1840 and 1850.

The authenticated customer node Cᵢ may move from Pⱼ to Pₖ. For Pₖ, the following Equation (48) may be satisfied.

PₖεGₖ^{o} (48)

At step 1810, the Cᵢ may send a switch request message Switch_{Req} to the Pⱼ. A changed service request may be sent from Cᵢ to Pⱼ via the switch request message. “Switch_{Req}” may indicate that the sent message is a message requesting the customer node Cᵢ to switch the service-providing entity that provides the service.

The switch request message may be configured as given by the following Equation (49):

Switch_{Req}=E_{S}ⁱ(Cᵢ∥N₀)∥Tₖ∥h(MEᵢ) (49)

N₀ may be a nonce determined by the Cᵢ.

The switch request message may include information about Tₖ for re-authentication of the Cᵢ.

Upon receiving the switch request message, the Pⱼ may derive a ticket Tₖ by decrypting the information in the switch request message using K_{S}ⁱ.

The Pⱼ may decrypt the second part, which is a second half of the ticket Tₖ, and may observe arguments or information extracted via the decryption of the second part. If the arguments or information are not originating from the Cᵢ, the Pⱼ may discard the arguments or information, and may mark the target that sent the message as a malicious user.

At step 1820, the Pⱼ may send the switch request message to the MEⱼ. The information in the switch request message at step 1820 may be identical to the information in the switch request message at step 1810. Alternatively, the Pⱼ may forward the switch request message to the MEⱼ.

Upon receiving the switch request message, the MEⱼ may derive the ticket Tₖ by decrypting the information in the switch request message using K_{S}ⁱ. Further, the MEⱼ may decrypt the ticket Tₖ.

Upon receiving the switch request message, the MEⱼ may retrieve the profile of the Cᵢ from the database using the identifier of the Cᵢ contained in the switch request message.

If the Cᵢ is eligible for further services, the MEⱼ may verify the authorization of the services from the profile.

Further, if the Cᵢ is eligible for further services, the MEⱼ may generate a session key K_{S}ⁱ. K_{S}ⁱ may be defined as in the following Equation (50):

Kₛⁱ=h(K_{c}ⁱ∥Vᵢ) (50)

If the Cᵢ is eligible for further services, the following steps 1830, 1840 and 1850 may be subsequently performed.

If the Cᵢ is not eligible for further services, the sent request may be ignored. Upon failing to decrypt the ticket Tₖ, the MEⱼ may ignore the request in the switch request message. Thereafter, the Cᵢ may start the initial authentication procedure. If the Cᵢ sends the switch request message several times, the MEⱼ may mark the Cᵢ as a malicious user.

At step 1830, the MEⱼ may send a switch challenge message to the Pⱼ. The switch challenge message may include the information given by the following Equation (51):

u₀^{new}∥E_{G}^{j}(Vᵢ∥N₁∥Tₖ) (51)

N₁ may be a nonce determined by the MEⱼ.

The MEⱼ may send u₀^{new} to the Pⱼ. u₀^{new} may be defined as in the following Equation (52):

u₀^{new}=E_{c}ⁱ(Tₖ∥T_{R}∥Kₛⁱ∥N₁∥N₀+1∥Pᵢ) (52)

The MEⱼ may issue a new ticket Tₖ based on a local index value, and may generate a new session key K_{S}ⁱ. The Pⱼ may retrieve a profile and K_{S}ⁱ from the ticket.

At step 1840, the Pⱼ may send a switch challenge forward message to the Cᵢ. The switch challenge forward message may include information u₀^{new}.

The Pⱼ may forward u₀^{new} to the Cᵢ.

The u₀^{new} of the switch challenge forward message may include N₀+1. Therefore, the switch challenge message at step 1830 and the switch challenge forward message at step 1840 may be responses to the challenges of the switch request messages at steps 1810 and 1820.

In u₀^{new} of the switch challenge forward message, N₁ may be a nonce determined by the MEⱼ. The switch challenge message and the switch challenge forward message may be challenges for the Cᵢ. N₁, which is the challenge for the Cᵢ, may be encrypted with the public key K_{C}ⁱ of the Cᵢ.

The Pⱼ may extract information N₁+1 from the switch challenge forward message using K_{C}ⁱ and may verify the challenge using N₁+1.

After the challenge has been verified, the Cᵢ may accept the ticket Tₖ.

At step 1850, the Cᵢ may send a switch response message to the switch challenge forward message to the Pⱼ. The switch response message may be a response to the changed service request at step 1810.

The switch response message may include the information given by the following Equation (53):

Eₛⁱ(Cᵢ∥N₁+1) (53)

The switch response message may include information N₁+1. Therefore, the switch response message may be a response to the challenge of the switch challenge message at step 1830 and the switch challenge forward message at step 1840.

The Pⱼ may extract N₁+1 from the switch response message using K_{S}ⁱ, and may verify the challenge using N₁+1.

After the challenge has been verified, the Pⱼ may provide a service to the Cᵢ.

If the challenge is not verified, the Pⱼ may halt the service and mark the ticket Tₖ as a void ticket.

Unless the Cᵢ is an element of the union of Gₖ^{o} and Gₖ, the Pⱼ may ignore the request and start an initial authentication procedure.

Below, operations in special cases other than the above-described embodiments will be described.

Restart of Chain

After the time of T_{d} has passed, the generation and distribution of the keychain may be restarted. During the time in which the keychain is distributed, each Pⱼ may generate a new Tₖ using old Kₛⁱ and may issue the new ticket Tₖ to all customers for which Tᵥ>0.

Tᵥ may be a valid time for a session key.

Tᵥ may be defined as in the following Equation (54):

Tᵥ=|lᵢ−L| (54)

lᵢ may be a system time during an i-th time interval in which the ticket and the session key were issued. L may be the time duration for the keychain.

Case where Cᵢ does not Obtain Response to Join Request or Switch Request During First Re-Authentication Procedure

During the procedure for the first case of re-authentication, described above with reference to FIG. 17, if the Cᵢ does not obtain a response to the join or switch request, the Cᵢ may resend the switch request in a slightly modified form. Two identical requests from the same Cᵢ may indicate the existence of an intruder. The Cᵢ may prevent the situation in which a lost request is misunderstood to be a replay attack by including a previous nonce in the message.

The following Equation (55) may indicate the information of the service request message, which is resent from Cᵢ to Pⱼ at step 1620.

E_{ME}^{j}(Cᵢ∥N₀∥N′₀)∥Solution (55)

The following Equation (56) may indicate the information of the switch request message, which is resent from Cᵢ to Pⱼ at step 1710.

Eₛⁱ(Cᵢ∥N₀∥N′₀)∥Tₖ∥Switch_{Req} (56)

Case where Cᵢ does not Obtain Response to Join Request or Switch Request During Second Re-Authentication Procedure

During the procedure for the second case of re-authentication, described above with reference to FIG. 18, if the Cᵢ does not obtain a response to the join request or switch request, the cases where the Cᵢ does not obtain the response may indicate the following situation presented in 1) to 3):

1) an intruder forges h(MEᵢ),

2) the Pⱼ cannot proceed the request due to the forgery, and

3) then Pⱼ ignores the request.

In this case, the Cᵢ may send the initial authentication request in the slightly modified form. The Cᵢ may prevent the situation in which a lost request is misunderstood to be a replay attack by including a previous nonce in the message.

The following Equation (57) may indicate the information of the service request message, which is resent from Cᵢ to Pⱼ at step 1620.

E_{ME}^{j}(Cᵢ∥N₀∥N′₀∥Tₖ∥Alert)∥Solution (57)

“Alert” may denote a warning against resending.

Mutual Authentication Between Customer Nodes (Cᵢ and Cⱼ)

It is assumed that two customer nodes Cᵢ and Cⱼ desire to directly communicate with each other. In order for the two customer nodes to authenticate each other, the two customer nodes may exchange predefined messages.

The predefined messages may include respective tickets and partial keys.

The predefined messages may be encrypted with respective session keys. The session keys may be session keys between C and P.

For example, the predefined messages may be represented by the following Equations (58) and (59).

The following Equation (58) may indicate a message from the Cᵢ to the Cⱼ.

Cᵢ→Cⱼ:Eₛⁱ(Cᵢ∥N₀∥Kᵢ^{P})∥Tₖ (58)

The following Equation (59) may indicate a message from the Cⱼ to the Cᵢ.

Cⱼ→Cᵢ:Eₛ^{j}(Cⱼ∥N₀+1∥N₁∥Kⱼ^{P})∥Tₖ (59)

In order to decrypt messages for authentication, both the Cᵢ and the Cⱼ may forward the messages to service-providing entities to whom the customer nodes are associated with.

After the exchange of a first message, three possible scenarios are present in relation to C-P association. A customer-customer mutual authentication protocol may proceed differently for a first scenario, a second scenario, and a third scenario, which will be described below.

First Scenario

A first scenario may proceed when the following Equation (60) is satisfied.

{Cᵢ,Cⱼ}ΔPⱼ (60)

In the first scenario, respective service-providing entities Pⱼ may decrypt the received messages and may retrieve partial keys for associated customer nodes via decryption. Pⱼ may send the partial keys, along with a challenge response, to the customer nodes Cᵢ and Cⱼ.

After the challenge has been verified, both the customer nodes Cᵢ and Cⱼ may generate a session key K_{i,j} there between to perform subsequent communication. K_{i,j} may be defined as in the following Equation (61):

K_{i,j}=H(Kᵢ^{p}⊕N₁∥Kⱼ^{p}⊕N₀) (61)

Second Scenario

A second scenario may proceed when the following Equations (62), (63), and (64) are satisfied.

{Pᵢ,Pⱼ}εGⱼ (62)

CᵢΔPᵢ (63)

CⱼΔPⱼ (64)

In the second scenario, the respective service-providing entities Pᵢ and Pⱼ may decrypt received messages and may retrieve partial keys for associated customer nodes via decryption. Pᵢ and Pⱼ may send partial keys, along with a response to a challenge, to respective Cᵢ and Cⱼ.

After the verification of the challenge, the customer nodes Cᵢ and Cⱼ may generate a session key K_{i,j} therebetween to perform subsequent communication. K_{i,j} may be defined as in the following Equation (65):

K_{i,j}=H(Kᵢ^{p}⊕N₁∥Kⱼ^{p}⊕N₀) (65)

Third Scenario

A third scenario may proceed when the following Equations (66), (67), and (68) are satisfied.

{Pᵢ,Pⱼ}εGⱼ⁰ (66)

CᵢΔPᵢ (67)

CⱼΔPⱼ (68)

In the third scenario, the service-providing entities Pᵢ and Pⱼ may forward the received messages to respective MEs so as to retrieve partial keys. The MEs may decrypt the messages and retrieve the partial keys for associated customer nodes via decryption. The MEs may send the retrieved partial keys to the Pᵢ and Pⱼ. After receiving responses including the partial keys from the MEs, the Pᵢ and Pⱼ may send the partial keys, along with a response to a challenge, to respective Cᵢ and Cⱼ.

After the challenge has been verified, both the customer nodes Cᵢ and Cⱼ may generate a session key K_{i,j} therebetween to perform subsequent communication. K_{i,j} may be defined as in the following Equation (69):

K_{i,j}=H(Kᵢ^{p}⊕N₁∥Kⱼ^{p}⊕N₀) (69)

The aforementioned apparatus may be embodied as a hardware element, a software element, and/or a combination of a hardware element and a software element. For example, the system, apparatus and elements described in embodiments may be embodied using at least one general-purpose computer or special-purpose computer such as a processor, a controller, an arithmetic logic unit (ALU), a digital signal processor, a microcomputer, a field programmable array (FPA), a programmable logic unit (PLU), a microprocessor, or another apparatus for executing and responding to an instruction. The processor may execute an operating system (OS) and at least one software application that runs on the OS. Also, the processor may access, store, operate, process, and create data in response to the execution of software. For the convenience of understanding, a single processor may be used, however, those skilled in the art may appreciate that the processor may include a plurality of processing elements and/or a plurality of processing element types. For example, the processor may include a plurality of processors or a single processor and a single controller. Further, another processing configuration such as a parallel processor is possible.

The software may include at least one of a computer program, a code and an instruction solely or in combination, configure the processor to operate as desired, or instruct the processor to operate independently or collectively. The software and/or the data may be embodied permanently or temporarily in any type of machine, component, physical equipment, virtual equipment, computer storage medium or device, or transmitted signal wave, in order to be interpreted by the processor or to provide the processor with the instructions or the data. The software may be distributed on computer systems connected over a network, and may be stored or implemented in the distributed method. The software and the data may be stored in one or more computer-readable storage media.

The methods according to the above embodiments may be implemented as program instructions that can be executed by various computer means and may be recorded on a computer-readable storage medium. The computer-readable storage medium may include program instructions, data files, and data structures, either solely or in combination. Program instructions recorded on the storage medium may have been specially designed and configured for the embodiments of the present invention, or may be known to or available to those who have ordinary knowledge in the field of computer software. Examples of the computer-readable storage medium include all types of hardware devices specially configured to record and execute program instructions, such as magnetic media such as a hard disk, a floppy disk, and magnetic tape, optical media such as compact disk (CD)-read only memory (ROM) and a digital versatile disk (DVD), magneto-optical media such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

As described above, there are provided an apparatus and method for providing a secure mutual authentication protocol for applications such as wireless power transfer, a sensor network, and an on-demand Ad-hoc network.

There are provided an apparatus and method that can use a secure and lightweight authentication protocol in a dynamic networking environment.

There are provided an apparatus and method that can authenticate communicating entities with minimal communication complexity.

There are provided an apparatus and method that can reduce a delay in an authentication procedure by authenticating communicating entities with minimal communication complexity.

Although the present invention has been shown and described with reference to limited embodiments and the accompanying drawings, it will be appreciated by those skilled in the art that various changes and modifications may be made from the above descriptions. For example, even if the aforementioned technologies are carried out in an order differing from the one described above and/or illustrated elements, such as systems, structures, devices and circuits, are combined or united in forms differing from those described above or are replaced or substituted with other elements or equivalents, the same results may be achieved.

What is claimed is:

1. An authentication method performed by an authentication entity, comprising:
forming a group of communication entities in a network;
generating a chain of keys required for authentication in the group; and
performing authentication of a customer node based on the keychain,
wherein respective keys in the keychain are valid for time intervals predefined for respective keys.

2. The authentication method of claim 1, wherein the keys are generated using an irreversible function.

3. The authentication method of claim 2, wherein the keys are used in the reverse order of direction in which the keys are generated by the irreversible function.

4. The authentication method of claim 1, wherein a commitment key of the group and the keys are generated based on a predefined value.

5. The authentication method of claim 4, wherein the predefined value is a valid time for the commitment key.

6. The authentication method of claim 1, wherein the authentication entity authenticates the customer node using a ticket sent from the customer node.

7. The authentication method of claim 1, wherein the selected key is a key corresponding to a time interval during which a service is provided to the customer node, among the keys in the keychain.

8. The authentication method of claim 1, wherein performing the authentication comprises issuing information about a ticket for re-authentication of the customer node to the customer node.

9. An authentication method performed by a service-providing entity, comprising:
sending a request to join a group of communication entities in a network to an authentication entity;
receiving key generation information from the authentication entity; and
generating a chain of keys required for authentication in the group based on the key generation information,
wherein respective keys in the keychain are valid for time intervals predefined for respective keys.

10. The authentication method of claim 9, further comprising:
receiving a request for a service from a customer node; and
sending a response to the service request to the customer node,
wherein the response to the service request includes information about a ticket issued by an authentication entity that performs authentication of the customer node.

11. The authentication method of claim 10, wherein information about at least a portion of the ticket is encrypted with a time-based key that is valid for a predefined time interval, among the keys in the keychain.

12. The authentication method of claim 9, further comprising:
receiving a request for a service from a customer node; and
sending a response to the service request to the customer node,
wherein the service request includes information about a ticket for re-authentication of the customer node, and
wherein information about at least a portion of the ticket is encrypted with a time-based key that is valid for a predefined time interval, among the keys in the keychain.

13. An authentication method performed by a customer node, comprising:
sending a request for a first service to a first service-providing entity; and
receiving a response to the request for the first service from the first service-providing entity,
wherein the response to the request for the first service includes information about a ticket issued by an authentication entity that performs authentication of the customer node, and
wherein information about at least a portion of the ticket is encrypted with a time-based key that is valid for a predefined time interval.

14. The authentication method of claim 13, further comprising:
sending a request for a second service to a second service-providing entity; and
receiving a response to the request for the second service from the second service-providing entity,
wherein the request for the second service includes information about the ticket for re-authentication of the customer node.

15. The authentication method of claim 13, wherein:
the ticket includes a first part and a second part, and
the first part is encrypted with a time-based key that is valid for a predefined time interval.

16. The authentication method of claim 15, wherein:
the second part is encrypted with a group key of a group of the authentication entity, and
the second part includes information used to determine the time-based key required to decrypt the first part.

17. The authentication method of claim 13, wherein the ticket is derived based on the customer node-specific information.
